(19) United States
(12) Patent Application Publication
(10) Pub. No.: US 2018/0231176 A1
(43) Pub. Date: Aug. 16, 2018

(54) STORAGE BRACKETS WITH MOVABLE STORAGE HOOKS

(71) Applicant: Pro-Mart Industries, Inc., Irvine, CA (US)

(72) Inventors: Azad Sabounjian, Irvine, CA (US); Sam Sabounjian, Irvine, CA (US)

(21) Appl. No.: 15/893,513

(22) Filed: Feb. 9, 2018

Related U.S. Application Data
(60) Provisional application No. 62/457,731, filed on Feb. 10, 2017.

(51) Int. Cl. F16M 13/02

(52) U.S. Cl. CPC F16M 13/02

(57) ABSTRACT

A bracket for releasably connecting to a support structure having a shaped opening. The bracket has a mounting plate with a rearward extending flange on each side of the mounting plate and extending a distance the same as a thickness t of the mounting plate. Two rivets extend from a back of the mounting plate with an enlarged head of the rivet configured to releasably interlock with the shaped opening. The rivets are aligned along an axis that is vertical during use. One of a hook or arm is connected to the front face and preferably rotatably mounted to rotate vertically between a folded position and an unfolded, use position where items can be hung from the hook or arm.

### CROSS-REFERENCE TO RELATED APPLICATIONS

The application claims the benefit under 35 U.S.C. § 119(e) to Provisional Patent Application No. 62/457,731 filed Feb. 10, 2017, the entire contents of which are incorporated herein by reference.

### BACKGROUND

Rack and shelving units have horizontal shelves and horizontal beams that interconnect with vertical posts using lugs that fit into arrays of slots on the vertical posts. But some items lend themselves to being hung or suspended vertically rather than laid horizontally on a shelf. A bracket from which to hang things is especially useful for flexible items, such as scarves, belts, ropes and cables, and things having straps such as backpacks, or flexible items such as coats. Current brackets may be screwed to a wall, but such brackets are not readily movable and are not readily connected to storage racks and are not readily connected to various positions on support structures such as walls. There is thus a need for an improved bracket on which to hang or suspend things.

Display systems often use a pegboard backing with various brackets having posts that pass through the aligned holes in the pegboard, as shown in U.S. Pat. No. 2,797,817. But such brackets may require hooks made of wires having different cross-sectional shapes, may require separating the brackets from the support base, are limited to pegboards, and once the brackets are connected, do not allow rotation of the hooks to a more-compact, folded configuration and instead require complete removal of the entire bracket or sometimes removal of the hook portion of the patent from the coupling portion that connects to a support structure. There is thus a need for an improved bracket having a folded, used position and a more compact, folded position without removing the bracket from its support structure and without removing the hook portion of the bracket from a coupling portion of the patent. Moreover, the prior art often achieves a reduced size configuration by removing the hook portion from the mounting bracket, but once separated, the hook portions easily become lost or misplaced. There is thus a need for such a bracket that achieves a reduced size or reduced storage configuration without separating parts of the bracket and subjecting the parts to risk of loss. There is a further need for a bracket made of simpler materials having uniform-cross-sectional shapes. There is a further need for a bracket where the hook is more securely and permanently fastened to the support base. There is also a still further need to a bracket that may connect to support structures other than pegboards.

Some brackets connect the hook portion to the base of the bracket at a location spaced apart a large distance from the mounting support, as in U.S. Pat. No. 3,289,994. The offset of the connection between the base of the bracket and the hook portion can exert large bending forces on the base and require more material be used to strengthen the base, which increases costs. There is thus a need for a bracket having a low profile base with a bracket connection close to the plane of the support member. There is a further need for a base that is simple to fabricate and uses less material.

### BRIEF SUMMARY

A bracket is provided that releasable couples to a support structure having a shaped opening. The bracket has a thin mounting plate with a rearward extending flange on each side of the mounting plate and extending a distance the same as a thickness t of the mounting plate, so the mounting plate thickness is 2t. Two rivets extend from a back of the mounting plate with an enlarged head of the rivet configured to releasably interlock with the shaped opening. The rivets are aligned along an axis that is vertical during use. One of a hook or arm is connected to the front face and preferably rotatably mounted to rotate vertically between a folded position and an unfolded, use position where items can be hung from the hook or arm.

The improved mounting portion may be formed of a single sheet of material and with a thickness of 2-10 times the thickness of the sheet of material a very low profile mounting portion is provided and one that may be easily fabricated. The preferred metal is steel with a thickness of about 1/16 inch (1.7 mm) for a hook 10 inches (about 220 mm) in length to carry a rated load of about 40 pounds (about 18 kg) from one hook, when the hook is made of 9/32 inch (7.2 mm) diameter steel wire. Thus, for the preferred embodiment t equals about 1/16 inch (about 1.7 mm) The use of rivets to form the connectors provides a simple assembly and reduces manufacturing costs. The short back flange and stiffening recesses provide a low profile mounting plate that helps reduce bending and distorting forces on the mounting plate yet provides a strong plate for mounting hooks several inches in length capable of carrying about 40 pounds or more, depending on the thickness of the sheet of material used for the mounting bracket and the size of the hooks from which items are suspended. For a hook about The rotatable mounting of hook portions to the mounting portion allows folded and unfolded positions of the hook portions of the bracket to achieve a smaller size but without removing the hook portions and subjecting them to risk of loss and without removing the entire bracket.

Some brackets connect the hook portion to the base of the bracket at a location spaced apart a large distance from the mounting support, as in U.S. Pat. No. 3,289,994. The offset of the connection between the base of the bracket and the hook portion can exert large bending forces on the base and require more material be used to strengthen the base, which increases costs

A bracket is provided for releasably connecting to a support structure having a plurality of first and second shaped openings that are aligned along a first axis. The bracket includes a mounting plate having a periphery with opposing front and back faces and made of metal having a thickness t. The bracket has a back flange extending along a substantial portion of the periphery and extending in a rearward direction. The back flange preferably extends a distance about the same as the thickness t. First and second connectors are aligned along a second axis that is parallel to the first axis and the connectors extend outward from the back face of the mounting plate. Each connector has an enlarged head configured to releasably interlock with corresponding ones of the first and second shaped openings. The enlarged heads are offset from the back face a distance sufficient to engage the correspond shaped opening while the flange contacts the support surface. A first recessed surface is formed in the front face and aligned with the second axis. The first recessed surface is offset toward the back face about the same distance as the thickness t. A support for hanging an item is connected to the mounting plate. The support preferably includes one of a hook or arm connected to mounting plate with a proximal rotating end of the hook or arm being at least partially encircled by a retaining part that is connected to the mounting plate to rotatably connect the hook or arm to the mounting plate and that is also orientated so the hook or arm rotates in a vertical direction during use.

In further variations, the bracket may include an insert in the first recessed surface that is interposed between the first recessed surface and the proximal rotating ends. A retainer connected to the mounting plate and encircling part of the insert and part of each proximal rotating end may rotatably connect each proximal rotating end to the mounting plate. A second recessed surface may be formed in the front face, with the second recessed surface offset toward the back face about the same distance as the thickness t. The second recessed surface is preferably aligned with the first recessed surface and with the second axis and more preferably one of the connectors is located between the two recessed surfaces.

In still further variations, the first and second connectors may each comprise a rivet extending through the mounting plate, the rivet having a circular enlarged head. The mounting plate is preferably a generally rectangular shape having two opposing sides and an opposing top and bottom, with the flange extending along at least a portion of each side of the generally rectangular shape.

The support for hanging an item may take variations. One variation includes a hook having a shank permanently connected to the front face of the mounting plate where the hook has concave hook end.

The support for hanging an item may include a pair of arms each having a proximal rotating end extending laterally and generally parallel to the front face and generally perpendicular to the second axis. Each proximal rotating end is rotatably connected to the mounting plate at the first recessed surface so each arm rotates between a first, unfolded, use position in which the pair of arms are generally perpendicular to the mounting plate and a second, folded position in which the pair of arms are generally parallel to the mounting plate.

This variation with rotating arms may include a stop portion extending parallel to the second axis and joined to the proximal rotating end, with the stop portion contacting the mounting plate to position the pair of arms in the first, unfolded, use position. A motion stop may also extend away from the front face a distance sufficient to contact one of the stop portions and position the arm in the second, folded position. The proximal, rotating end of each arm may be permanently connected to each other.

A distal end of each pair of arms may be connected. A distal end of each pair of arms may be is upwardly inclined and connected by a straight end piece. A distal end of at least one of the pair of arms may have an upwardly inclined end when in the first, use position. A distal end of at least one of the pair of arms may have a curve at the distal end which curve is concave when the at least one of the pair of arms is in the first, use position.

A first distance may separate the stop portions and a second distance may separate distal ends of each of the pair of arms, where the second distance being greater than the first distance. Each arm may be parallel for a substantial length of each arm. Each arm may be straight for a substantial length of each arm and the arms may have an included angle of about 20° to 40° between them.

The support for hanging an item may also include first and second hooks each located on a different side of the second axis and each having a top, straight portion extending along a lateral axis that parallel to the front surface and perpendicular to the second axis. Each top, straight portion is rotatably connected to the mounting plate to rotate about that longitudinal axis. Each first and second hook may have a hook portion opening in a direction away from each other and depending below the bottom of the mounting plate.

In further variations of these hooks, a connecting member may connect the first and second hooks to the mounting plate. The connecting member may have connecting arms fastened to the mounting plate and may also have a laterally extending top member and bottom member which are parallel to each other but spaced apart from each other. First and second connecting plates may be located on opposing sides of the second axis, with each first and second connecting plate connected to the top member and to the bottom member. A first tubular connector may be fastened to a front side of the first connecting plate and a second tubular connector fastened to a front side of the second connecting plate. Each top, straight portion may then be rotatably connected to the mounting plate by the top straight portion of the first hook rotating inside the first tubular connector and the top straight portion of the second hook rotating inside the second tubular connector.

In still further variations of these hooks, the first and second connecting plates may each have a top side forming a top elongated recess which receives a portion of the top member, and the first and second connecting plates may each have a bottom side forming a bottom recess which receives a portion of the bottom member. The first and second hooks are on a front side of the top and bottom members, while a portion of the top and bottom elongated recess are on a back side of the top and bottom members.

There is also preferably provided a bracket for releasably connecting to a support structure having a plurality of first and second shaped openings that are aligned along a first axis, with a support connected to the bracket. The bracket may include a generally rectangular mounting plate having opposing sides and an opposing top and bottom sides. The mounting plate preferably has opposing front and back faces and a thickness of about t. The mounting plate preferably has a back flange extending along a substantial portion of a periphery of the mounting plate and extending along a portion of each side of the mounting plate. The back flange extends in a rearward direction a distance about the same as the thickness t. First and second connectors are aligned along a second axis that is parallel to the first axis and extend outward from the back face. Each connector may have an enlarged head configured to releasably interlock with corresponding ones of the first and second shaped openings. The enlarged heads are offset from the back face a distance sufficient to engage the correspond shaped opening while the flange contacts the support surface. At least one recessed surface may be formed in the front face with that recessed surface offset toward the back face about the same distance as the thickness t. The at least one recessed surface is located along the first axis and located between the two connectors. The bracket may also include a pair of arms each having a proximal rotating end extending laterally and generally parallel to the front face and generally perpendicular to the second axis. Each proximal rotating end is rotatably connected to the mounting plate at the first recessed surface to rotate the pair of arms vertically between a first, unfolded, use position in which the pair of arms are generally perpendicular to the mounting plate and a second, folded position in which the pair of arms are generally parallel to the mounting plate.

In further variations of this bracket, an insert is placed in the at least one recessed surface so the insert is interposed between the at least one recessed surface and the proximal rotating ends. A retainer is connected to the mounting plate and encircles part of the insert and part of each proximal rotating end to rotatably connect each proximal rotating end to the mounting plate. Advantageously, each connector comprises a rivet extending through the mounting plate with the enlarged head being circular.

### BRIEF DESCRIPTION OF THE DRAWINGS

These and other advantages and features of the invention will be better appreciated in view of the following drawings and descriptions in which like numbers refer to like parts throughout, and in which:

FIG. 1 is a perspective view of storage hooks on an elongated support frame;

FIG. 2 is an exploded view of the storage hooks and support frame of FIG. 1;

FIGS. 3A, 3B and 3C are front, top and bottom views, respectively, of an elongated support frame in the form of a runner plate;

FIG. 3D is a sectional view of the elongated support frame of FIG. 3A, taken along section 3D-3D;

FIGS. 4A and 4B are front and back perspective views, respectively, of a closed hook assembly as shown in FIG. 1, in a use position;

FIGS. 4C, 4D, 4E, 4F and 4G are side, top, bottom, front and back views of the closed hook assembly of FIG. 4A;

FIGS. 5A and 5B are front and back perspective views, respectively, of the closed hook assembly of FIG. 4A in a folded, upright, storage position;

FIG. 5C is a left side view of the closed hook assembly of FIG. 5A in a folded, upright, storage position, with the right side view being the mirror image thereof;

FIG. 6A is a sectional view of the closed hook assembly of FIGS. 4A-4E, taken along section 6A-6A of FIG. 4D;

FIG. 6B is a front view of FIG. 4C, showing section 6C-6C;

FIG. 6C is a section of FIG. 6B, taken along section 6C-6C of FIG. 6B;

FIG. 7A is an enlarged front view of FIG. 4C, showing section 7B-7B;

FIG. 7B is a sectional view of FIG. 7A taken along section 7B-7B;

FIGS. 8A and 8B are front and back perspective views, respectively, of a double hook assembly having curved end portions as shown in FIG. 1, in an unfolded, use position;

FIGS. 8C, 8D, 8E, 8F and 8G are front, top, bottom, right side and left side views of a double hook assembly having curved end portions as shown in FIG. 4A;

FIGS. 9A and 9B are front and back perspective views, respectively, of the double hook assembly having curved end portions of FIGS. 8A-8G in a folded, upright, storage position;

FIG. 9C is a right side view of the double hook assembly having curved end portions of FIGS. 9A and 9B in an upright, folded, storage position, with the left side view being a mirror image thereof;

FIGS. 10A and 109B are front and back perspective views, respectively, of a double hook assembly having inclined ends as shown in FIGS. 1-2, in an unfolded, use position;

FIGS. 10C, 10D, 10E, 10F. and 10G are front, top, bottom, right side and left side views of the double hook assembly having inclined ends of FIG. 10A;

FIGS. 11A and 11B are front and back perspective views, respectively, of the double hook assembly having inclined ends of FIGS. 10A-10G in a folded, upright, storage position;

FIG. 11C is a right side view of the double hook assembly having inclined ends of FIGS. 11A and 11B but in an upright, folded storage position, with the left side view being a mirror image thereof;

FIGS. 12A and 12B are front and back perspective views, respectively, of a saddle hook assembly as shown in FIGS. 1-2, in an unfolded, use position;

FIGS. 12C, 12D, 12E, 12F and 12G are front, top, bottom, right side and left side views of the saddle hook assembly of FIG. 12A;

FIGS. 13A and 13B are front and back perspective views, respectively, of the saddle hook assembly of FIGS. 12A-12G in a folded, upright, storage position;

FIG. 13C is a right side view of the saddle hook assembly in the upright, folded, storage position, with the left side view being a mirror image thereof;

FIGS. 14A and 14B are front and back perspective views, respectively, of a double side-hook assembly as shown in FIGS. 1-2, in a depending, use position;

FIGS. 14C, 14D, 14E, 14F and 14G are front, top, bottom, right side and left side views of the double side-hook assembly of FIG. 14A;

FIG. 15A is an enlarged view of FIG. 12A showing Section 15B, 15B;

FIG. 15B is a partial sectional view taken along section 15B-15B of FIG. 15A;

FIGS. 16A and 16B are front and back perspective views, respectively, of a J-hook assembly as shown in FIGS. 1-2; and

FIGS. 16C, 16D, 16E, 16F and 16G are front, top, bottom, right side and left side views of the J-hook assembly of FIG. 16A.

FIGS. 17A-17E are back perspective views, showing a sequence of steps for bending each side of the flat plate of FIG. 17A to form a flange along at least a portion of the side of the plate;

FIG. 18A is a back view of the plate of FIG. 17E showing one of two, L-shaped flanges, bent toward the front;

FIG. 18B is a back perspective view of the back of the plate of FIG. 18A showing one both L-shaped flanges bent toward the front;

FIGS. 18C and 18D are back and top views, respectively, showing the plate of FIG. 18B with a top part of the left flange bent horizontal to form a motion stop;

FIGS. 18E and 18F are back and top views, respectively, showing the plate of FIGS. 18C and 18D with the top part of both flanges bent horizontal to form a motion stop;

FIG. 18G is a back perspective view of the plate of FIGS. 18E and 18F;

FIGS. 19A and 19B are back and front perspective views, respectively, of the plate of FIG. 18G with two, rearward extending recesses formed therein to form the mounting plate of FIGS. 1-2;

FIG. 20A is a perspective view of a storage shelving unit having a mounting bracket and hanger assembly of FIG. 4A connected thereto; and

FIG. 20B is an enlarged view taken along section 20B-20B of FIG. 20A.

### DETAILED DESCRIPTION

A list of the various part numbers used herein is as follows: 10—runner plate; 12—slot; 14—slot axis; 16a, 16b—sides of plate; 18a, 18b—flanges' 20a, 20b—offsets between web and flange; 22—web; 28—closed hook assembly; 30a, 30b—arms; 32—hook end; 33a. 33b—laterally offsetting arm portion; 34—mounting plate; 36—stop portion; 37—rotation portion; 38—coating on legs; 40—retainer; 42—legs on retainer; 44—holes in plate 34; 46—foot; 48—insert; 50—first recess in plate 34; 52—second recess; 56—motion stop; 58a, 53b—legs of motion stop; 60—flanges on plate 34; 64—first connector; 66—second connector; 68—head; 70—shaft; 72—upsetting end; 78—double hook assembly; 80a, 80b curved end portions; 88—double hook assembly; 90a, 90b upwardly inclined end portions; 98—saddle assembly; 100—closed end; 102a, 102b—vertical arm portion; 104a, 104b-parallel arm portion; 110—double side-hook assembly; 112—side hook; 116—hook portion; 118—top, straight portion; 120—tubular connector; 122—snap clip; 126—connecting bracket; 128—top member; 129—bottom member; 130—connecting plate; 131—elongated recess; 132a, 132b—connecting arms; 140—J-hook connecting assembly; 142—J-hook; 144—shaft; 146—hook portion; 148—flat plate; 150—circular hole; 152—holes for legs; 154—slot; 156—L-shaped flanges; 160—shelving unit; 162—shelf; 164—posts.

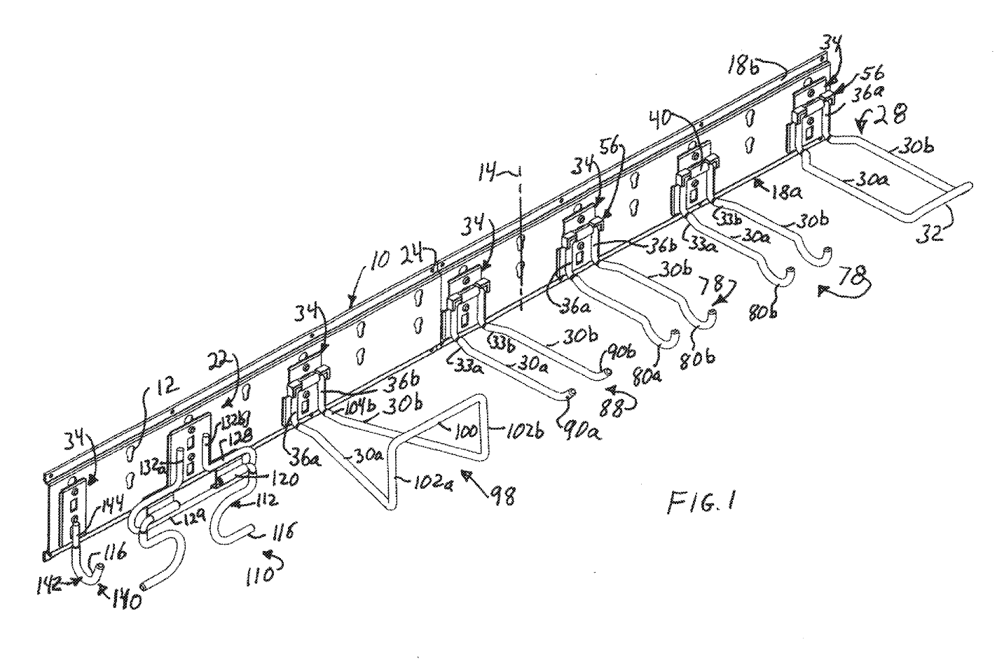

Referring to FIGS. 1-3D, a storage system is shown having various storage hooks on a support. The support for the storage hooks may take various forms and is shown in FIGS. 1-2 as an elongated, runner plate 10 having a plurality of shaped openings 12 extending through the plate. The openings 12 are shown as having a keyhole shape with a larger sized opening on top and a smaller sized opening on the bottom. The top and bottom openings may be different sizes, and shapes with overlapping circular or rectangular openings being preferred where the upper opening is larger in the later direction than the overlapped, lower opening. More preferably, the top portion of the slot is formed by a circular hole overlapping a short, downward extending, generally rectangular slot having a rounded bottom end. The smaller sized, lower portion of the opening 12 may be vertically aligned with the larger opening, or at an angle thereto so that some or all of the opening 12 is inclined. The openings 12 preferably extend along a longitudinal axis 14 and thus preferably form an elongated slot which extends along an axis 14 that is preferably, but optionally, generally vertical during use. Advantageously there are at least two elongated openings 12, vertically aligned along a common slot axis 14, with a plurality of pairs of openings 14 arranged periodically along a length of the runner plate 10. As the opening 12 preferably comprises an elongated opening with an upper end larger than the lower end, the opening will be referred to herein as slot 12. But the shape of openings can vary, and may include rectangular openings of uniform width, square openings or circular openings.

The depicted runner plate 10 is preferably made of an elongated strip of metal having a thickness t with two opposing top and bottom sides 16a, 16b that are parallel to each other and bent over toward the opposing side and pressed flat to form a double thickness flange 18a, 18b extending along each of the sides 16a, 16b. An offset 20a, 20b extends along a different one of each flange 18a, 18b, from opposing top and bottom sides of a central web 22 which extends the length of the runner plate. The slots 12 are formed in the web 20, with the web preferably being parallel to flanges 18a, 18b and perpendicular to the offsets 20a, 20b. The offsets 20a, 20b are preferably short in length, about 2-10 times the thickness t of metal from which the plate is made, and more preferably a length of about 2-5 times the thickness t. The flanges 18a, 18b stiffen the runner plate 10 while reducing weight and material used to form the plate, but various lightening and stiffening mechanisms may be used.

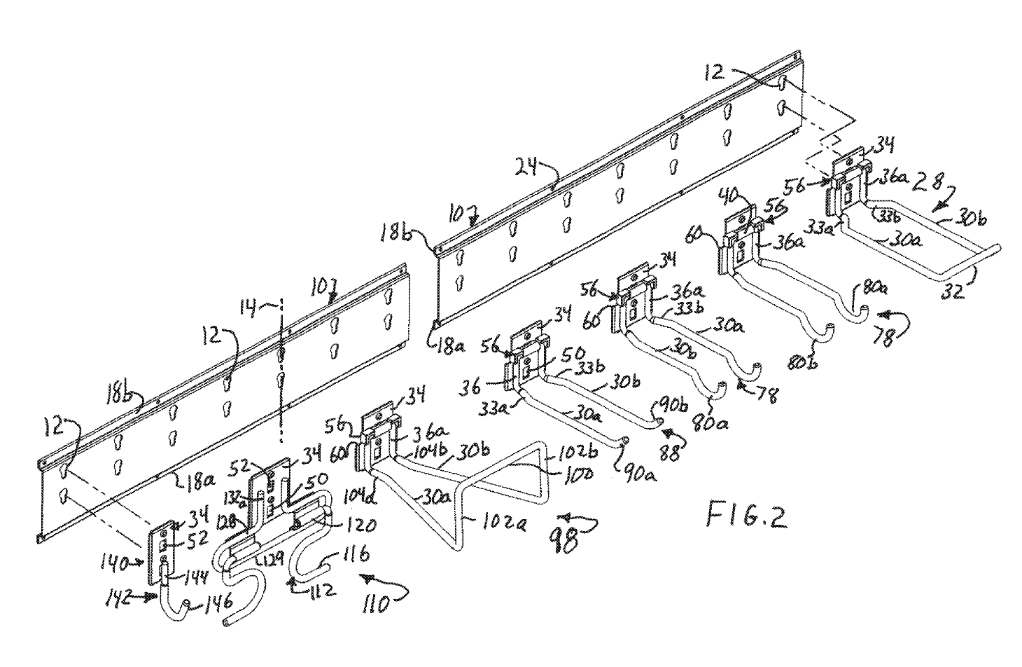

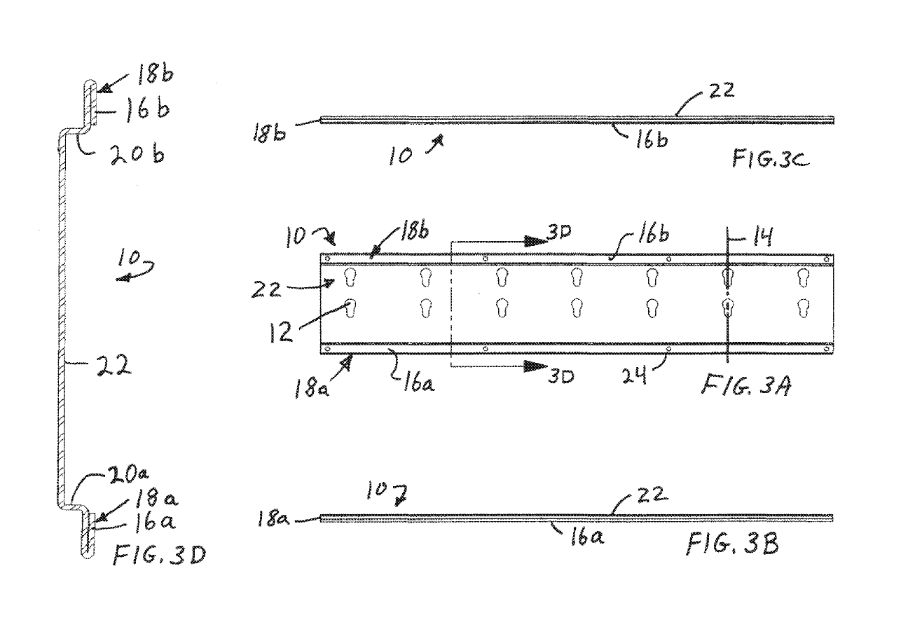

Preferably, but optionally, fastener holes 24 (FIG. 3A) are formed periodically through the flanges 18a, 18b. Various fasteners can pass through the fastener holes 24 to hold the runner plate 10 to a building support, such as a wall, a frame or other support structure. The plate 10 is preferably made of stainless steel or other metals, but may be made of various plastics, fiberglass, polymers, wood or fiberboard. Depending on the material, the size, configuration and use of flanges 18a, 18b will vary.

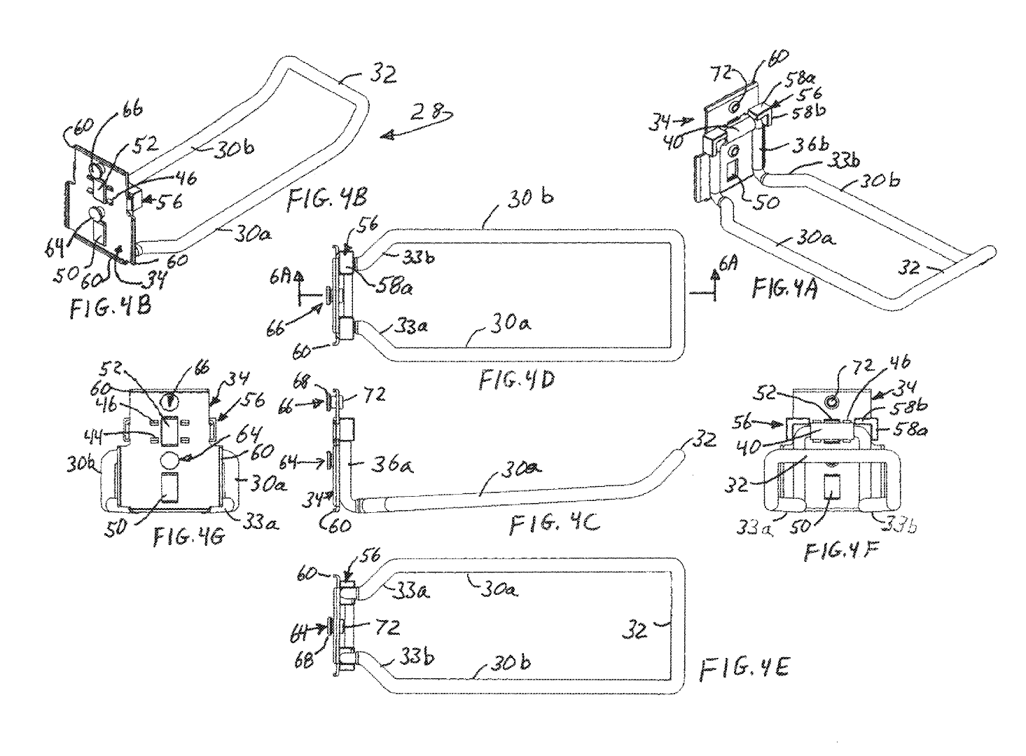

Referring further to FIGS. 1-6, various brackets may be coupled to the mounting support illustrated by runner plate 10. The various brackets may use the same or similar mounting plates. FIGS. 4-6 show details of a closed hook assembly 28 having first and second arms 30a, 30b forming a closed loop with a free end forming an upturned or upwardly extending end free end that is connected by straight end-piece 32, and having the proximal ends of the arms fastened to a mounting plate 34. By providing two arms 30a, 30b joined together at their distal end by straight end-piece 32, a stronger support is provided for suspended items as a strap suspending such an item will pass over two arms. By providing two arms joined together at their distal end there is also provided a broader support because the arms 30a, 30b are adjacent each other but are spaced apart from each other. Thus, a delicate scarf may be placed over both arms with less risk of creasing or wrinkling than if placed over one arm. In addition to joining the two arms, the closed end formed by straight end-piece 32 also avoids snagging on the distal end when placing items on the hook formed by the arms.

As used herein, the relative positions and directions above and below, up and down, upwards and downwards, higher and lower, are relative to the vertical axis along the direction of gravity, when the parts are in the orientation of FIGS. 1-2. The lateral direction or position is relative to a plane orthogonal to that vertical axis. The proximal and distal directions and positions are relative to the mounting plate 34, with proximal being closer to plate 34 and distal being further away from plate 34. The relative directions and position front and back, forward and rearward, are with respect to the front and back of the mounting plate 34 and generally along the horizontal axis when in the unfolded, use position.

The arms 30a, 30b form a generally rectangular hook as they are spaced apart a lateral distance that is substantially the same for a substantial length of the arms 30 and the closed hook assembly 28, while adjacent the proximal end of the closed hook assembly the arms 30a, 30b are bent inward at arm portion 33a, 33b (FIGS. 4D, 4E) at an angle of about 45° toward each other and toward the mounting plate 34 which is narrower in width than the spacing between the arms. As alternatively described, as also seen in FIGS. 4D and 4E, from the stop portions 36, the arms 30a, 30b are angled outward from each other at arm portion 33a, 33b each of which is adjacent the respective stop portion 36a, 36b and mounting plate 34. This laterally outwardly (or inward) extending arm portion 33a, 33b allows the lateral space between paired and adjacent arms 30a, 30b to be varied. The laterally offsetting arm portion 33a, 33b preferably begins very close to the plane of the mounting plate 34 when the arms 30a, 30b are in the unfolded, use position. The laterally offsetting arm portion 33a, 33b increases the forces on the mounting plate 34 and placing the offsetting arm portion closer to the mounting plate causes less distortion in the arms 30a, 30b.

The proximal end of each arm 30a, 30b preferably has a stop portion 36a, 36b that is bent upwards at the mounting plate 34 and extends parallel to the mounting plate 34 from a bottom to a top portion of that mounting plate before bending at a right angle to a form proximal arm 37 (FIG. 7A) extending laterally toward a corresponding proximal arm 37b (FIG. 7A) on the other proximal end. The proximal arms 37a, 37b represent the proximal ends of each arm 30a, 30b and are referred to herein as both the proximal ends 37a, 37b and the proximal arms 37a, 37b. The stop portion 36a, 36b abuts the mounting plate 34 to restrain rotation of the arms in a downward direction. The stop portion 36a, 36b is generally perpendicular to the distal portion of the arms 30a, 30b.

The proximal ends 37a, 37b of each arm 30a, 30b preferably abut each other and may be separate or permanently fastened together by melting material (e.g., spot welding), or by adhesives or other mechanical fastening mechanisms. A portion of each of the arms 30a, 30b may be coated with a resilient material 38 such as an elastomer or polymer preferably selected to reduce oxidation of the arms and preferably selected to grip items suspended on the arms when in the extended position.

The arms 30a, 30b may comprise cylindrical rods that are bent into the desired shape and dipped or sprayed with coating 38. The arms 30a, 30b are generally perpendicular to the mounting plate 34 in the use position, preferably inclined slightly upward at an angle of about 5° to about 15° relative to the horizontal and an angle of about 5° to about 15° relative to an axis perpendicular to the plane of the mounting plate 34. While the arms are slightly upwardly inclined, as used herein the arms are nonetheless generally perpendicular to the mounting plate 34. A slightly downward inclination of the arms 30a, 30b, below the horizontal and beyond about 5° is not considered generally perpendicular as used herein. The distal straight end-piece 32 of the hook assembly 28 is preferably inclined upward at an angle of about 45° to the horizontal or about 30-35° relative to a plane containing the outwardly extending arms 30a, 30b. The slight upward inclination keeps straps and things looped over the arms from slipping off easily.

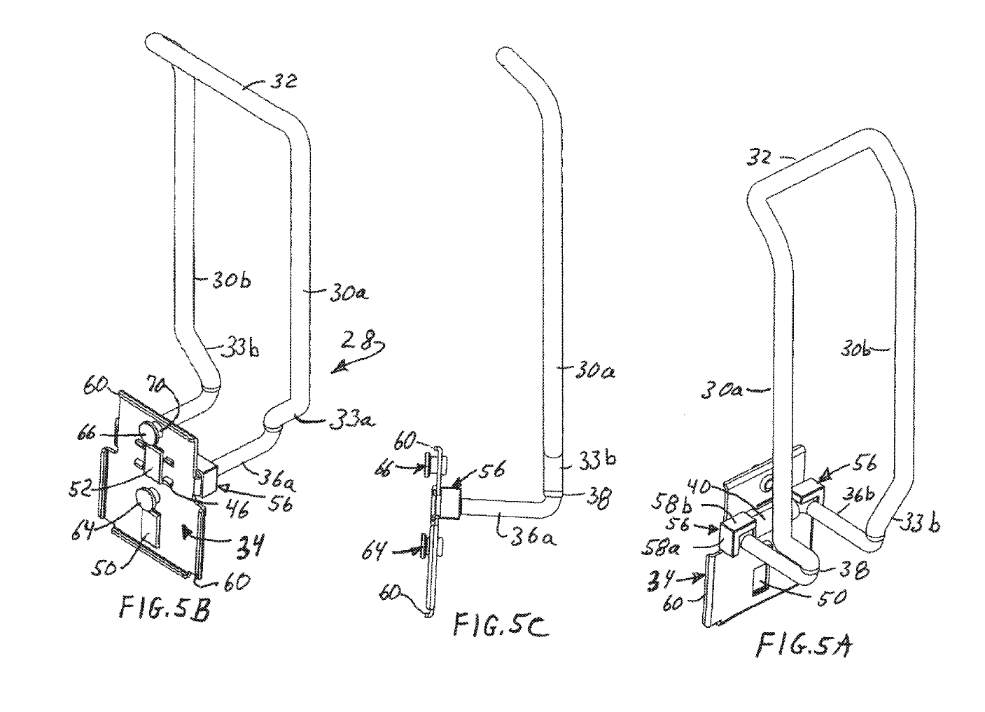

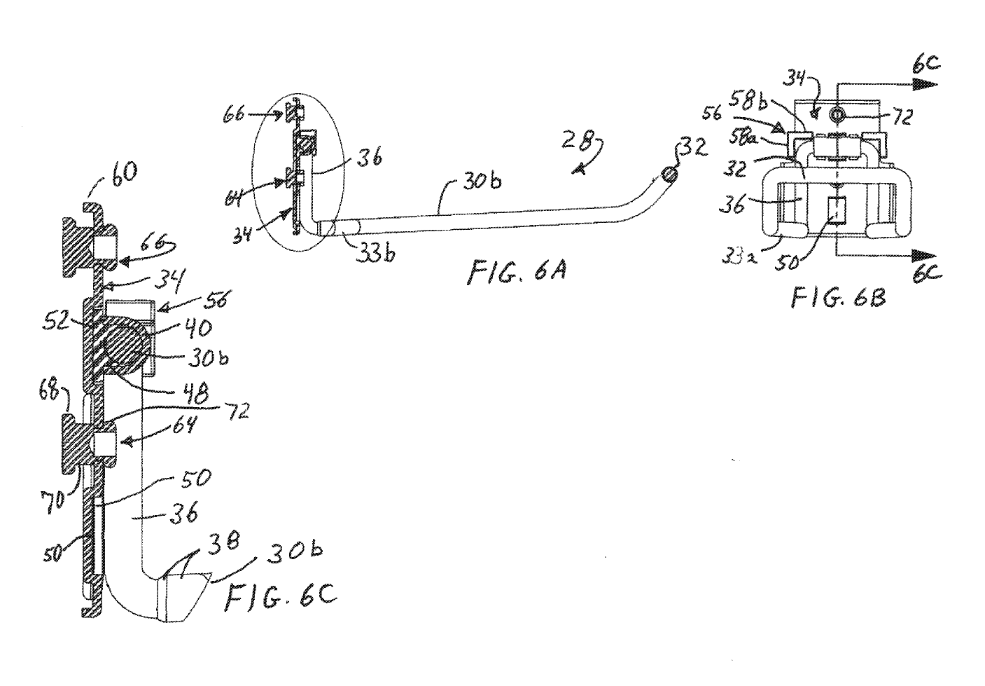

The proximal end of arms 30a, 30b, may be permanently coupled to the mounting plate 34, as by spot welding or adhesives. Preferably though, the closed hook assembly is rotatably mounted to rotate in a substantially vertical during use by placing a retainer 40 over the proximal ends of the arms 30a, 30b which form short arms 37 extend laterally toward each other and which preferably abut each other. Referring to FIGS. 6-7, retainer 40 comprises a sheet of material forming a tunnel having a U-shaped cross section complementary in size and shape to the preferably circular cross-sectional shape of the arms 30a, 30b. At the opposing ends of the retainer 40 and on opposing top and bottom sides of the retainer legs 42 are formed with sufficient length to extend through small holes 44 in the mounting plate 34 sized to allow passage of one of the (preferably) four legs on the retainer. The end of each leg 42 which is distal to the body of the retainer 40, after passing through its respective hole 44, is bent outward to form a retaining foot which inhibits passage back through the hole 44. Each foot 46 is part of the leg 42 that extends through one of the holes 44 in the mounting plate 34.

The retainer 40 preferably does not immovably couple the arms 30a, 30b to the mounting plate 34, but preferably allow the laterally extending proximal arms 37a, 37b to rotate about an axis extending along a length of the retainer 40, which axis is preferably horizontal during use. An insert 48 (FIG. 6C) may be optionally interposed between the mounting plate 34 and the proximal ends of arms 30a, 30b and the retainer 40 to make it easier to rotate the arms and closed hook assembly 28. The depicted insert 48 has a slot with a curved bottom forming a groove that receives a short length of each proximal end of each arm 30a, 30b, with the curvature of arms matching the curvature in the bottom of the groove to allow the arms to rotate within the groove. An insert 48 made of a soft metal such as brass, or preferably molded of plastic or an elastomer or polymer is believed suitable. The insert 48 advantageously has a flat bottom surface that fits within one of a first or second recess 50, 52 the mounting plate 34. Preferably upper recess 52 is vertically above but spaced apart from lower recess 50, with the insert 48 located in upper recess 52. The shape of the insert 48 and recess 50, 52 are preferably complementary and selected to prevent rotation in a plane parallel to the major surface of the mounting plate, and make it easier to support, align and rotate the laterally-extending proximal ends 37 of the arms 30a, 30b. Thus, as shown in FIGS. 4A, 4B, 5A, 5B, the arms 30a, 30b may have a first, unfolded, generally horizontal position to allow items to be hung from or suspended from the arms, or they may be rotated in a substantially vertical plane to a second, folded position where the arms are generally vertical—depending on the location of motion stops 56 which may limit the rotation of the arms.

Preferably, at least one and more preferably two, rotation stops or motion stops 56 are placed above the retainer 40 to limit the rotation of the arms 30a, 30b relative to the mounting plate 34. Various motion stops may be used that are connected to the mounting plate 34. The depicted motion stops 56 comprises a vertical strip of the mounting plate 34 cut parallel to one side of the plate. The strip of material forms a first leg 58a that is bent perpendicular to the front face of the mounting plate and in the direction of the arms 30a, 30b during use, with the strip of material then bent parallel to the front face of the mounting plate to form leg 58b that is located to abut one of the arms as the leg rotates. The deformation of part of the mounting plate 34 to form the motion stop(s) 56 prevents the mounting plate 34 from being perfectly rectangular but the shape is considered generally rectangular as used herein.

The motion stop 56 is interposed between the mounting plate 34 and at least one of the arms 30a, 30b adjacent the mounting plate as the at least one arm rotates—in order to limit the rotation of the at least one arm in an upward direction toward the top of the mounting plate 34. The motion stop 54 could be a separate part fastened to the mounting plate 34. The motion stop 54 is on the plate and located above the axis of rotation of the proximal ends of the arms 30a, 30b in order to limit upward rotation of the arms 30a, 30b.

Referring to FIGS. 4-7 and the sub-figures therein, the mounting plate 34 comprises a generally rectangular plate its opposing top and bottom sides and its opposing left and right sides being bent away from the arms 30a, 30b to form back flanges 60 that preferably extend around a substantial portion of the periphery of the mounting plate 34. The back flanges 60 are short flanges, preferably having height of about the thickness t of the plate and less preferably a height 3-5 times that thickness.

The mounting plate has opposing front and back sides with the arms 30a, 30b connected to the front side and at least two connectors, first and second connectors 64, 66 extending from the back surface and located on a first axis which is preferably vertical. Each connector 64, 66 has a distal end configured to interlock with a mating recess such as slot 12 in another part. The interlocking end and recess preferably take the form of a hooked end or an enlarged head with the but other interlocking configurations may be used. The interlocking end will be described in terms of the preferred embodiment which uses an enlarged head 68 (FIG. 6C) having a narrower shaft portion 70 (FIG. 6C) or body portion extending between the enlarged head 68 and the mounting plate 34, but the interlocking end is not so limited in shape nor is the recess or slot 12. Advantageously, each connector 64, 66 comprises a rivet having a stepped cylindrical shape with enlarged head 68, narrower diameter shaft or body portion 70 and a further narrowed diameter end 72. The rivet is placed through a hole in the mounting plate with the narrower diameter shaft abutting the back of the mounting plate, and the end 72 being upset on the front side of the mounting plate to couple the rivet to the mounting plate. Rivets made of metal, preferably steel, are believed suitable to form connectors 64, 66. The shaft 70 is long enough so that the back of the enlarged head 68, which back faces toward the back of the mounting plate 34, can fit through the enlarged portion of slot 12 while the shaft 70 can fit into the narrower, elongated portion of the slot 12, while the back flanges 60 abut the web 22 of the runner plate 10 to connect the mounting plate 34 to the runner plate. That provides a stable support for the mounting plate. The enlarged head 68 is preferably located a distance of about 1t to about 5t from the end of the flanges 60, and less preferably a distance of up to about 10t from the end of the flanges 60. This distance is from the engaging portion of the enlarged head 60, which in the depicted embodiment is from the face of the head 60 facing the mounting plate 34. This distance depends on the thickness of the web 22 of the running plate 10 as the slots 12 are formed in the web. As the nature of the support in which the slots 12 are formed may vary, the length of the shaft 70 will vary, and may exceed 10t.

The connectors 64, 66 may be uncoupled from the runner plate 10 by moving the mounting plate 34 upward until the enlarged head 68 can exit the slot 12 in the plate. The coupling of the connectors 64, 66 to the mating slots 12 advantageously provides a secure connection with the mounting plate 34 as the connector's shaft 70 preferably allows enough length to easily couple the connectors to the corresponding slots but is short enough that there is not much play or looseness with the connection. The back flanges 60 abut the web 22 of the runner plate 10 to prevent wobbling laterally or vertically. The

Preferably, the first and second recesses 50, 52 and the first and second connectors 64, 66 are centered along a common axis, such as the first axis, which axis is vertical during use. Thus, the proximal ends of the arms which rotate inside retainer 40 extend in a lateral direction that is perpendicular to the first axis. Preferably, the recesses 50, 52 and connectors 64, 66 alternate so one recess 50, 52 is located between two vertically spaced connectors 64, 66. As seen in FIGS. 4B, 4B and 5B, the (four) holes 44 (FIG. 7B) for the legs 42 of the retainer 40 are formed around the upper recess 52 with one adjacent each corner of the preferably rectangular recess. But the number of holes 44 will vary with the number of legs holding the retainer 40 to the mounting plate 34 and the shape of the recess may also vary.

Referring to FIGS. 6A and 6C, the end of the back flanges 60 and the back of the recesses 50 are in the same plane on the back side of the mounting plate 34 and preferably serve to stiffen and strengthen the mounting plate. The front side of the remaining portions of the mounting plate 34 are also preferably in the same general plane. As best seen in FIG. 6C, the front plane and back plane of the mounting plate 34 are close together to present a low profile mounting plate, preferably having a total thickness of about 2t, and less preferably a total thickness of 2-6 times the thickness of the metal from which the mounting plate is made. The low profile (small thickness) helps reduce bending forces on the mounting plate and provides a good load transfer from the arms 30a, 30b through the stop portion 36a, 36b of the arms abutting the front side of the mounting plate 34.

In use, the runner plate is fastened to a desired support, such as a wall, by fasteners through the fastener holes 24, or other connections. The mounting bracket 34 is manually positioned to pass the connectors 64, 66 through corresponding slots 12 with the plate moving downward to engage and interlock the connector shafts 70 with the narrower portion of the slots 12. The arms 30a, 30b may be grabbed manually to help position and manipulate the mounting plate to achieve the connection or disconnection of the parts. For a more compact configuration for shipping or storage in the assembled configuration, the arms 30a, 30b may be manually rotated to the folded position (FIGS. 5A-5C), with the front side of the stop portions 36a, 36b abutting the motion stops 56, in which position the arms 30a, 30b are preferably substantially parallel with the mounting plate 34. The arms are rotated generally horizontal for use, with the back side of each stop portion 36a, 36b abutting the front face of the mounting plate. The closed hook assembly 28 may be positioned as desired for coupling to the runner plate 10, and the assembly 28 may be rotated to the unfolded use position or folded storage position as desired. Items may be hung or suspended on the arms 30a, 30b or straight end-piece 32 of the closed hook assembly 28 as desired.

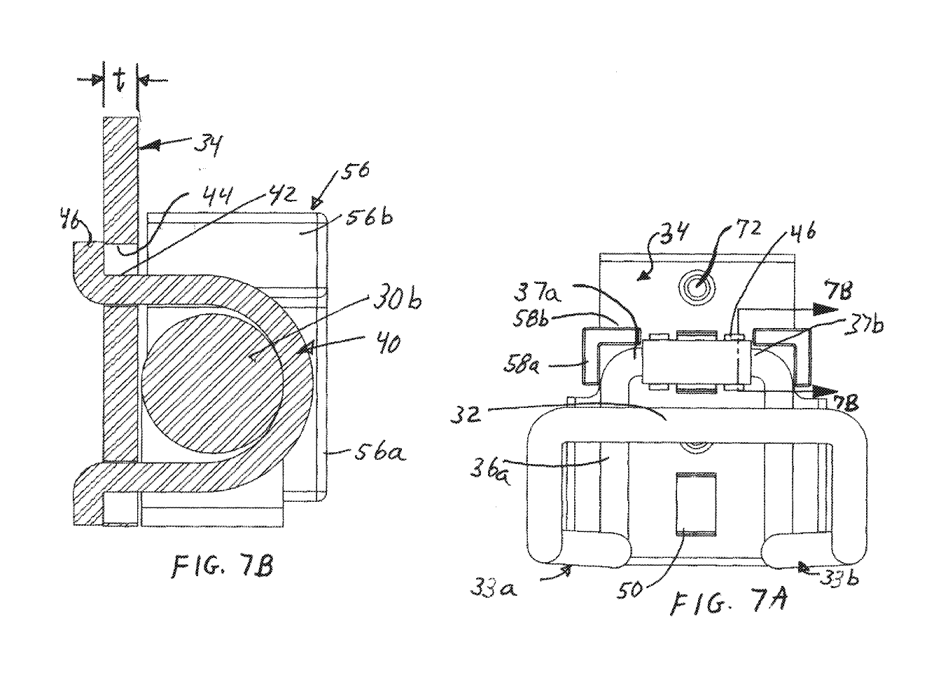

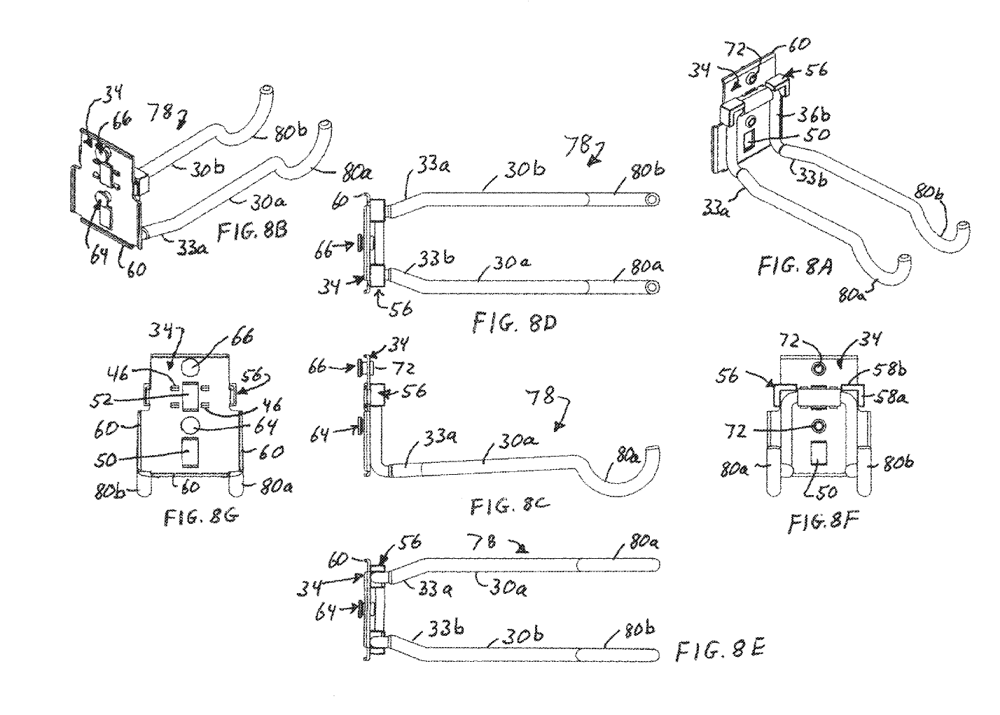

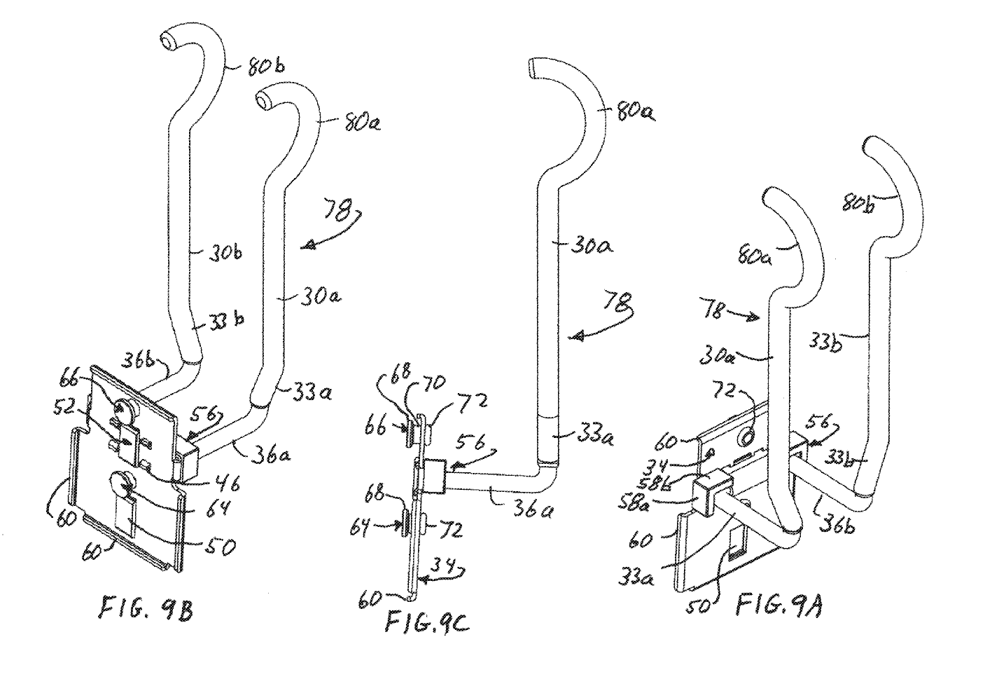

Referring to FIGS. 8-9, an assembly 78, referred to as a double hook assembly 78, having curved end portions 80a, 80b, is disclosed. The basic construction is the same as the closed hook assembly 28 except for the arms 30 and the description of the common parts is not repeated. Thus, the double hook assembly 78 has arms 30 rotatably connected to mounting plate 34 with connectors 64, 66 for releasably coupling the mounting plate and assembly 78 to running plate 10. But instead of the distal end of arms 30a, 30b joining with a straight end-piece 32 as in the closed hook assembly 28, the arms 30a, 30b of the double hook assembly 78 having curved end portions 38 of FIGS. 8-9 are not joined by straight end-piece 32 and instead have a concave, downwardly curved end 80a, 80b, at or adjacent to the distal end of each respective arm 30a, 30b. While the distal ends of arms 30a, 30b are not joined it is preferred that the proximal end of the arms 30a, 30b in this embodiment are joined by spot welding the end of rotating portions 37a, 37b (FIG. 7a) together so the arms rotate together inside the retainer 40 and so that the arms with curved ends 80a, 80b may be manually moved together. Other mechanisms can be used to join the rotating arms 37 (e.g., adhesives, threaded connections, etc.). Less preferred, each arm 30a, 30b with its curved end 80a, 80b may rotate separately by not connecting the proximal ends of the arms beneath retainer 40. Thus, while it is preferred arms 30a, 30b with respective curved ends 80a, 80b move together between a folded position (FIGS. 9A-9C) and unfolded position (FIGS. 8A to 9G), the arms may move separately between each position.

The arms 30a, 30b having curved ends 80a, 80b, respectively. The curved ends 80a, 80b are preferably semi-circular, and from 1-2 inches in diameter, but the curvature may vary. The curved ends 80a, 80b may have straight sides forming a V-shaped curve, or a U-shaped curve, and the reference to a curved recess or curved end 80a, 80b encompasses these shapes. The curved ends 80a, 80b provide a smaller, localized holding area that may offer advantages in holding various items, such as straps of purses, belts or other items having straps with widths about the same as the diameter of the curved ends 80a, 80b. By providing two arms 30a, 30b adjacent each other, a strap may be looped over one or both arms, depending on the weight of the item or to provide a broader support (across two arms) for the suspended item or a narrower support (over one arm), as desired. Some items may crease more easily if placed over one arm and not crease if placed over two arms.

As best seen in FIGS. 8D and 8E, the arms 30a, 30b are angled outward from each other adjacent the stop portions 36a, 36b by laterally offsetting arm portion 33a, 33b. This offset allows the lateral space between paired and adjacent arms 30a, 30b to be varied. As each arm 30a, 30b may support separate items a larger lateral spacing may allow more items to be placed on each arm before the items on adjacent arms hit each other, and the greater space allows more manual access to items suspended on each arm. The lateral space between the arms 30a, 30b and their respective hooks 80a, 80a, may be adjusted by varying the length and angle of the lateral offsetting arm portion 33a, 33b, which as described above, preferably begins at the stop portions 36a, 36b and mounting plate 34 when the arms are in the unfolded position.

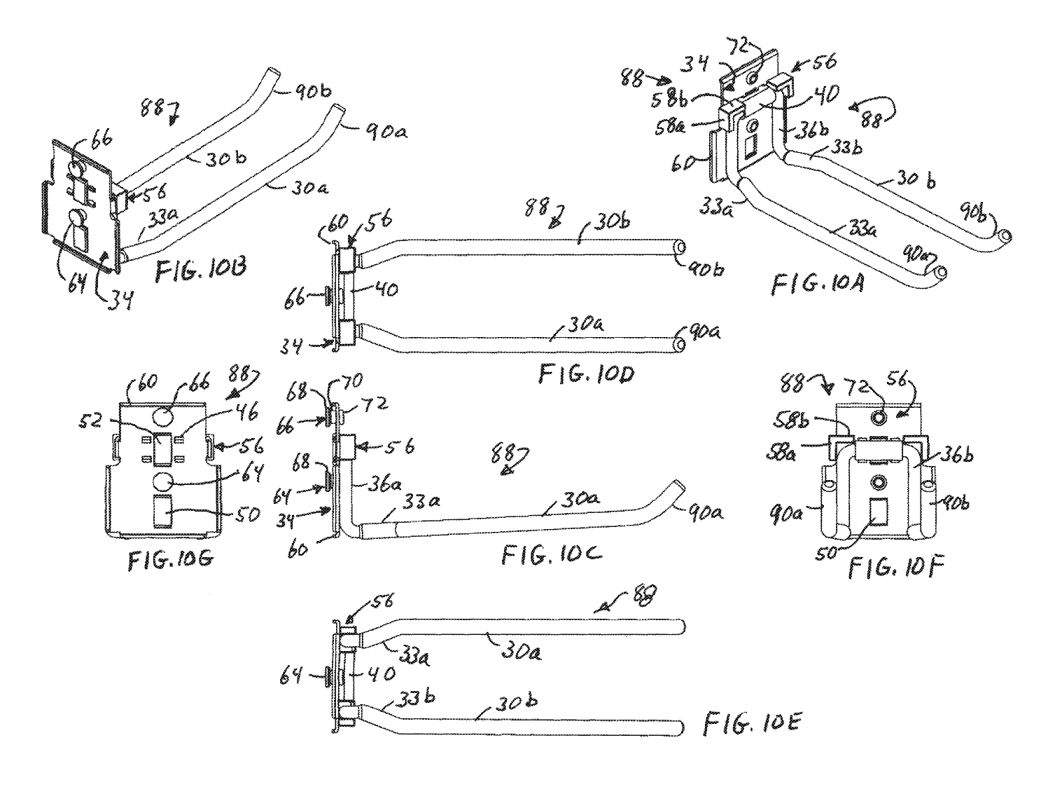

Referring to FIGS. 9-10, a double hook assembly 88 having upwardly inclined ends 90a, 90b on each end of arm 30a, 30b, is disclosed. The basic construction is the same as the closed hook assembly 28 and the double hook assembly 78, except for part of the arms 30, so the description of the common parts is not repeated. Thus, the double hook assembly 88 has arms 30a, 30b rotatably connected to mounting plate 34 which has connectors 64, 66 for releasably coupling the mounting plate and assembly 88 to running plate 10. But instead of the distal end of arms 30a, 30b having a closed end as in straight end-piece 32 or curved end portions 80a, 80b, the distal end of the arms in the double hook assembly 88 with inclined ends has upwardly inclined end portions 90a, 90b on different ones of the respective arms 30a, 30b. The upwardly inclined end portions 90a, 90b preferably begin about 0.5 to 1.5 inches (12-37 mm) before the distal end of the end portion, and incline upwardly at an angle of from about 10° to about 60° relative to the longitudinal axis of the arm 30 on which the inclined end is located. An upwardly inclined angle of about 45° relative to the long axis of the arm is believed preferable for the end portions 90a, 90b.

The upwardly inclined end portion 90a, 90b helps prevent straps suspended on the arms 30a, 30b from sliding off the end. The arms themselves are preferably slightly inclined upward an angle of slightly inclined upward at an angle of about 5° to about 15° relative to the horizontal and an angle of about 5° to about 15° relative to an axis perpendicular to the plane of the mounting plate 34. While the arms are slightly upwardly inclined, as used herein the arms are nonetheless generally perpendicular to the mounting plate 34. A slightly downward inclination of the arms 30a, 30b, below the horizontal and beyond about 5° is not considered generally perpendicular as used herein. Because of the slight upward inclination, the weight of an item hung or suspended on one or both of the arms 30a, 30b must bend the arm(s) downward a greater amount before the strap or other suspending mechanism begins to slide off the arm, with the inclined distal end 90a, 90b further restraining the strap from slipping off the end.

As with the double hook assembly 78 having (downwardly) curved end portions 80a, 80b, the assembly 78 with upwardly inclined ends 90a, 90b may have each arm move separately between the first, unfolded position (FIGS. 10A-10G) and the second, folded position (FIGS. 11A-11B). Alternatively, and preferably, the proximal ends of the two rotation portions 37 are fastened together so both arms 30 rotate together.

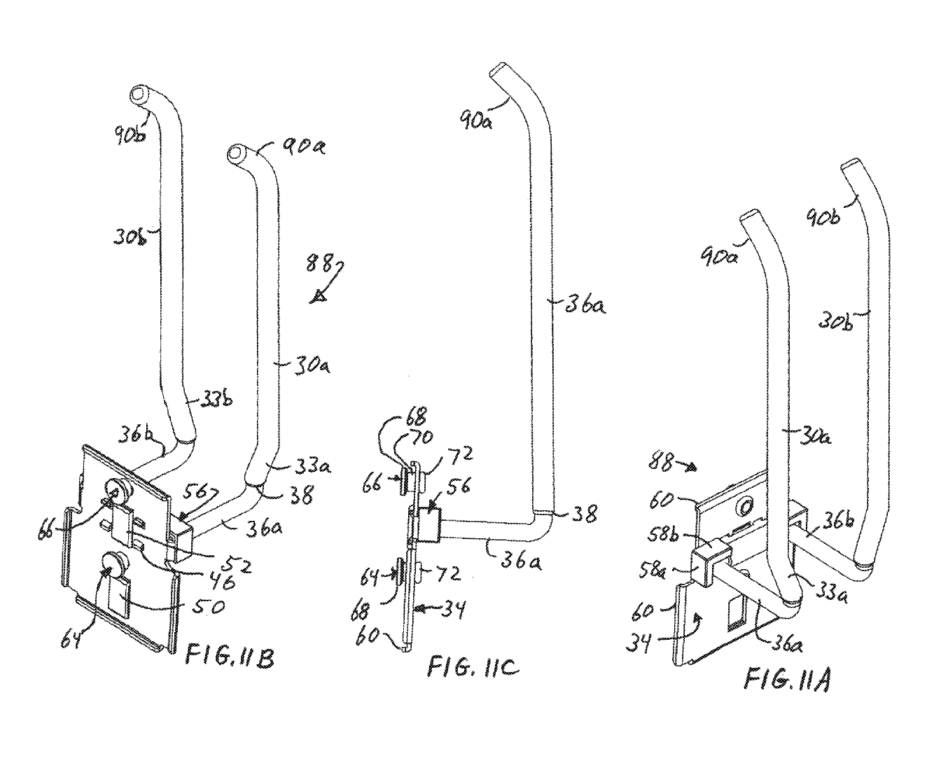

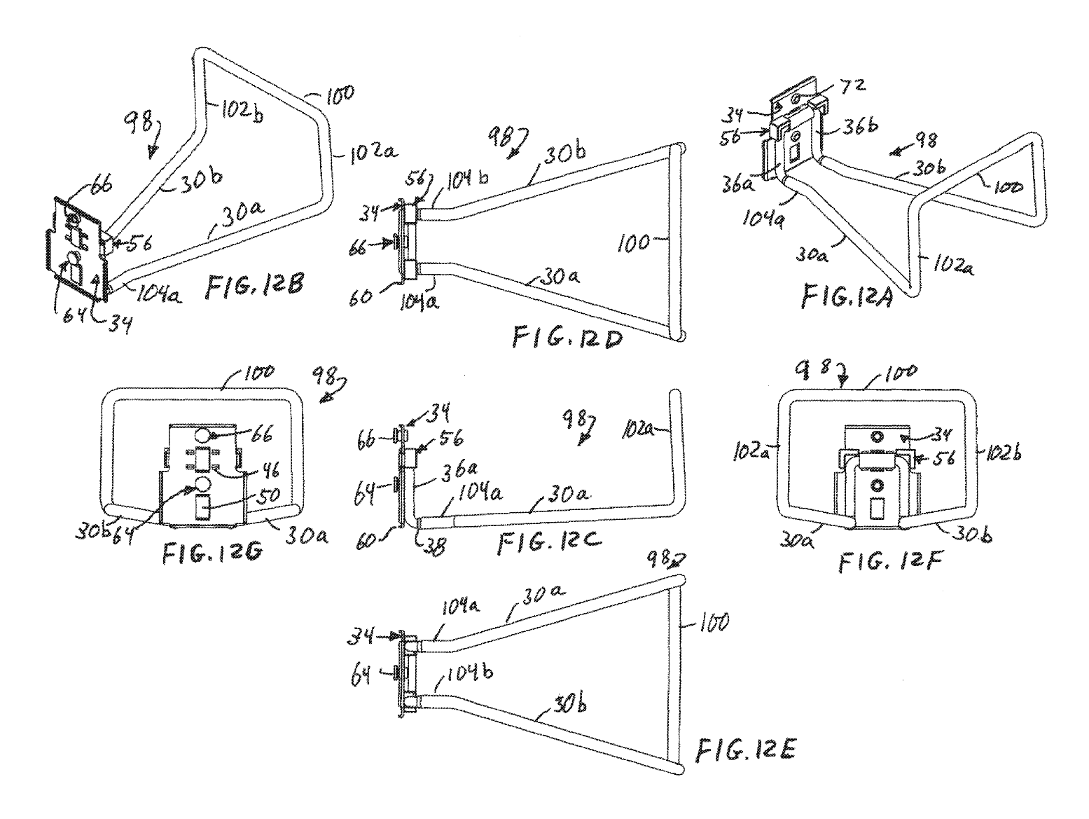

Referring to FIGS. 12-13, a saddle assembly 98 is shown having a closed end 100 and a generally triangular profile when viewed from the top or bottom. The basic construction is the same as the closed hook assembly 28 and the double hook assemblies 78, 88, except for the arms 30, so the description of the common parts is not repeated. Thus, the saddle assembly 78 with closed end 100 has arms 30 rotatably connected to mounting plate 34 with connectors 64, 66 for releasably coupling the mounting plate and assembly 78 to running plate 10. The distal ends of each arm 30a, 30b are joined by closed end as formed by straight end-piece 32 in the closed hook assembly 28, with the closed end having short, vertical arm portions 102a, 102b extending upward at an angle of about 90° to the longitudinal axis of the arms 30a, 30b to which the arm portions 102a, 102b are connected. The arms 30a, 30b are in substantially the same plane. Thus, the closed end 100 extends perpendicular to the plane of the arms 30a, 30b and when the arms are in the unfolded, use position the arm portions 102a, 102b and closed end 100 are generally perpendicular to the legs, and preferably generally vertical during use.

The proximal ends of the arms 30a, 30b for saddle assembly 98 are joined by spot welding the end of rotating portions 37a, 37b (FIG. 7a) together so the arms rotate together inside the retainer 40 and so that the arms with curved ends 80a, 80b may be manually moved together. Other ways of joining the rotation portions 37a, 37b may be used. Thus,

As best seen in FIGS. 12D and 12E, the arms 30a, 30b are angled away from each other and when viewed from the top or bottom (perpendicular to the plane of arms 30a, 30b), the arms and closed end 100 form a generally triangular shape. Advantageously, the arms 30a, 30b diverge at an angle of about 10° to about 20° relative to an axis perpendicular to the front side of the mounting plate 34. Preferably, the included angle between the straight portion of the arms 30a, 30b is about 20° to about 40°, and more preferably about 30°. The arms 30a, 30b are closer together adjacent the mounting plate 34 than at the closed end 100.

As best seen in FIGS. 12C, 12F and 12G, in the unfolded position the arms 30a, 30b have parallel arm portions 104a, 104b that extend from the mounting plate 34, such that each arm portion 30a, 30b is in the same plane as the respective stop portion 36a, 36b to which the arm portion 104a, 104b is connected. Advantageously, the arm portions 104a, 104b are parallel only for a short distance of a few inches, about 1-3 inches (2-8 cm) before splaying laterally apart.

As best seen in FIGS. 12C, 12F and 12G, in the unfolded position the arms 30a, 30b are slightly inclined upward at an angle of about 5° to about 15° relative to the horizontal and an angle of about 5° to about 15° relative to an axis perpendicular to the plane of the mounting plate 34. While the arms are slightly upwardly inclined, as used herein the arms are nonetheless generally perpendicular to the mounting plate 34. A slightly downward inclination of the arms 30a, 30b, below the horizontal and beyond about 5° is not considered generally perpendicular as used herein. The upward inclination offsets some of the downward deformation of the arms 30a, 30b when an item is suspended from the arms.

The saddle shape of the splayed arms 30a, 30b and upwardly extending end 100 help slide straps suspended over the arms toward the mounting plate 34 and parallel arms portions 104a, 104b. The slight upward inclination of legs 30a, 30b help slide straps suspended over the arms toward the mounting plate 34 and parallel arms portions 104a, 104b. The closed end 100 raised by vertical arm portions 102a, 102b help prevent any straps passing over the arms 30a, 30b from sliding off the end of the saddle assembly 98.

As shown in Figs. C, the arms 30a, 30b may be unfolded to a first, unfolded position that is generally horizontal, for use. The arms 30a, 30b may be moved to a second, folded position with the arms 30a, 30b generally vertical (FIGS. 13A-13) for storage, shipping or to reduce chance contact with the saddle assembly 98.

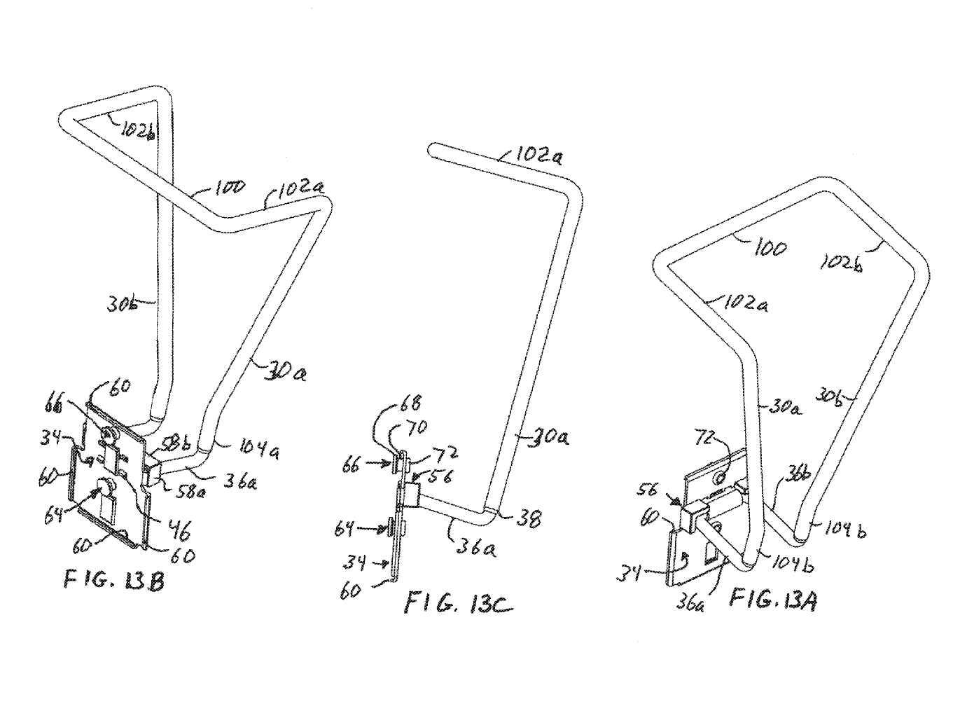

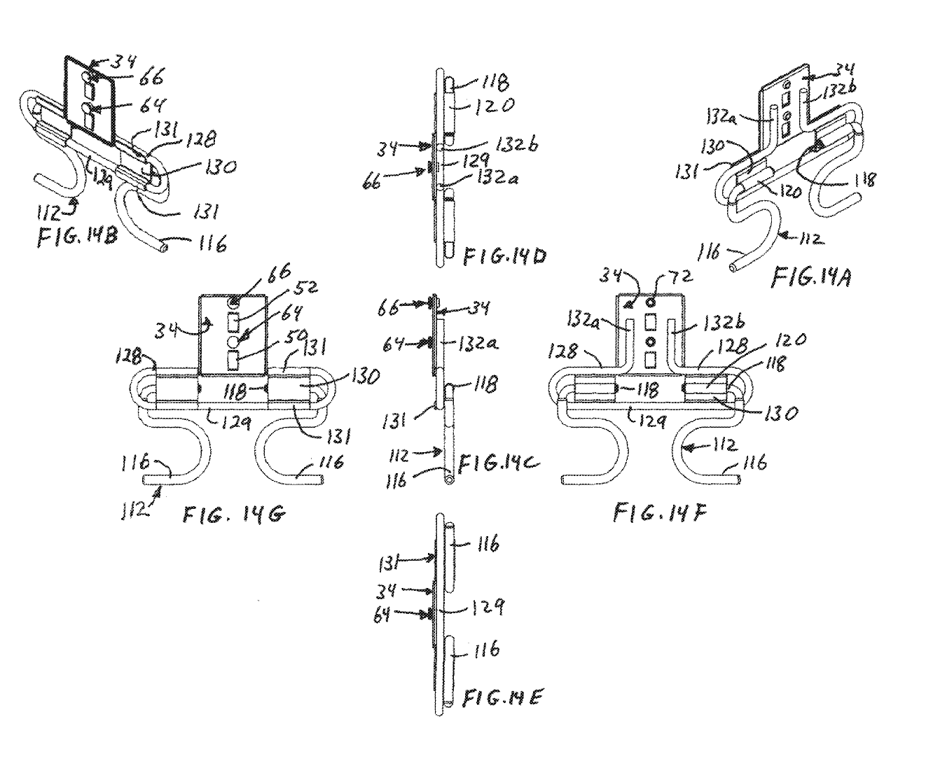

Referring to FIGS. 14-15, a double side-hook assembly 110 is shown having the same mounting plate 34 as describe herein, but with two side-hooks 112 and no arms 30. The basic construction of the mounting plate 34 is the same so the description of the common parts of the mounting plate is not given again. Each side-hook 112 has a member forming a hook portion 116 opening to one side of the mounting plate 34 from which the hook is suspended. The hook portion 116 side is shown having a C-shaped. The hook portion 116 is connected to a top, straight portion 118 which is rotatably mounted.

In the preferred embodiment the top, straight portion 118 is the top of an S shaped part and the hook portion 116 is the middle and bottom of the S shaped part, both formed by bending a rod in the general shape of an S. The rod preferably has a circular cross-section. In FIG. 14G, the left side hook 112 opens to the left with the top, straight portion 118 fitting inside tubular connector 120 to rotate within that tubular connector. The top, straight portion 118 extends through the tubular connector 120 and has a groove encircling the distal end of that straight portion 118 so a resilient, snap washer or snap clip 122 fits over the free end of the straight portion 118 and fits inside that groove. The snap clip 122 is larger than the passage through tubular connector 120 so the top, straight portion 118 of the side hook cannot be pulled out of the tubular connector 120, but can rotate inside that tubular connector.

The top, straight portion 118 is preferably connected to the hook portion 116 by a curved support so the left handed side hook 112 and top, straight portion 118 resemble the letter S. The hook portions 116 open laterally on opposing sides of the mounting plate 34 so one of the S-shapes is reversed by rotating it 180° about a vertical axis. The hook portions 116 could open in the same lateral direction but that restricts access to the lateral opening of the hook so it is preferred to have them face opposing directions.

If a single side hook portion 116 is used the tubular connector 120 may be welded or otherwise fastened to the mounting plate 34, or the rotating connection for the legs 37 may be used. But preferably the hook portions 116 are spaced apart a distance such that the inside of the laterally opening hook portions 116 are spaced apart a distance about the same as the width of the mounting plate so the hook portions may swing free without hitting the mounting plate. To achieve this a wider spacing, a connecting bracket 126 is provided. The connecting bracket 126 is preferably formed by bending a rod to form an elongated, flattened oval with parallel opposing sides and rounded corners that is connected to the mounting plate. The connecting bracket 126 has parallel top and bottom members 128, 129, joined by curved ends which space the members 128, 129 a distance apart. Each tubular connector 120 is fastened to a support plate 130 that extends between and is connected to the top and bottom members 128, 129. Spot welding the connector 120 to its plate 130 and spot welding opposing sides of the plate 130 to members 128, 129 are believed suitable. Other connections can be used, including melting, soldering and riveting of metal parts, adhesives, or molding the parts of plastic. The preferred connection is described later.

The top member 128 is connected to the mounting plate 34. Preferably, the top member has two upwardly extending, connecting arms 132a, 132b which are connected to mounting plate 34, preferably by spot welding. The connecting bracket 126 may thus be formed by bending a single rod to form a depending connecting arm 132a which extends laterally to form half of top member 128, and then curves downward before forming bottom member 129 and then curving upward to form the other half of top member 129, which then is bent upward to form connecting arm 132b. The connecting bracket 126 resembles the top of the letter T, but inverted, and may be provided by an inverted, T-shaped plate to which the connecting plates 130 are fastened or to which the tubular connectors 120 are fastened. But the bent rod form of connecting bracket 126 is believed lighter weight and preferred as a way of providing a laterally offset, rotating connection for each of the hook portions 116.

Preferably, an elongated recess 131 having a C-shaped, or U-shaped or hat-shaped cross-section is formed along each opposing top and bottom side of plate 130 with the recess 131 configured to receive the top member 128 and bottom member 129, and more preferably to snap fit into the respective recess or snap-fit onto the respective members. The snap-fit connection may be suitable for applications is sufficiently strong no further connection (e.g, welding, deformed material, adhesives etc.) is needed to connect the plate 130 to the top and bottom members 128, 129. Preferably, the connecting plate 130 with the elongated recesses 131 on opposing top and bottom sides of the plate is passed horizontally through the space between the top and bottom members 128, 129 and then rotated into a vertical position so the (top) elongated recess 131 on the top side of plate 130 may snap onto the top member 128 while the (bottom) recess 131 on the bottom side of the plate 130 may snap onto the bottom member 129. This places the connecting plate 130 on the back side of the members 128, 129 while the side hooks 112 are on the front side of the members 128, 129, with the tubular connector and top, straight portion 118 located in front of the members 128, 129 as best seen in FIGS. 14A and 15A. In this construction the hook portion 116 can rotate about 180° and possibly more, with the side hook 112 abutting the bottom member 129 to limit rotation in the downward direction and the side hook 112 abutting the top member 128 to limit rotation in the upward direction. Advantageously, the side hooks 112 can hang vertically downward in the unfolded, use position, with the hook portion 116 located below the bottom member 129. The side hooks 112 may be folded upward to place the hook portion 116 adjacent the plane of the mounting plate 134 to reduce the size of the side hook assembly 110.

In use, a strap or other flexible, elongated member may be inserted laterally into the opening of one of the hook portions 116, with the side hook 112 being rotated outward and upward as needed to make that insertion easier. Optionally, the strap or flexible, elongated member may be passed through the laterally-opening hook portions 116 of two adjacent hook portions 116, again with the side hooks 112 being rotated outward and upward as needed to make that insertion easier.

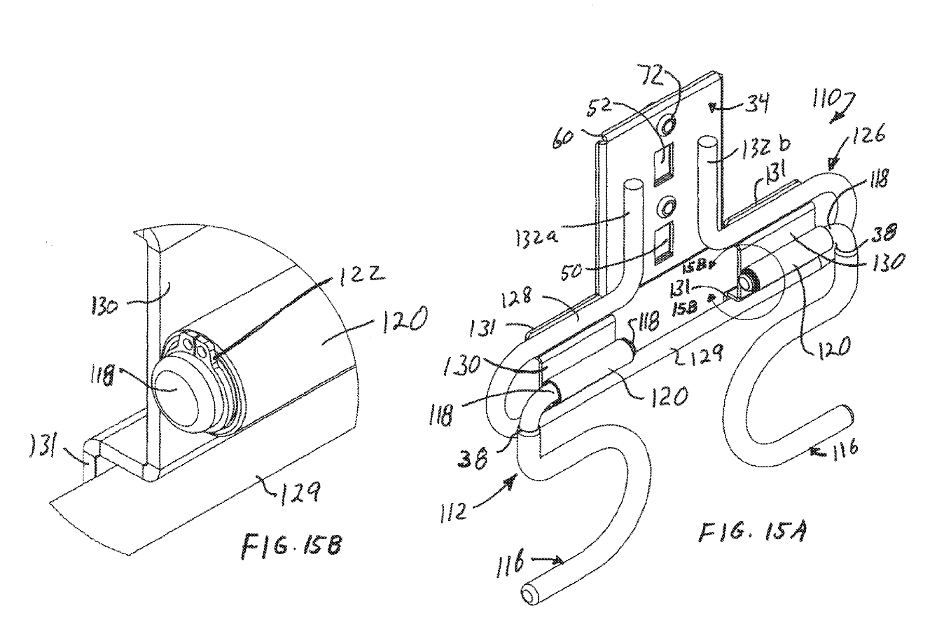

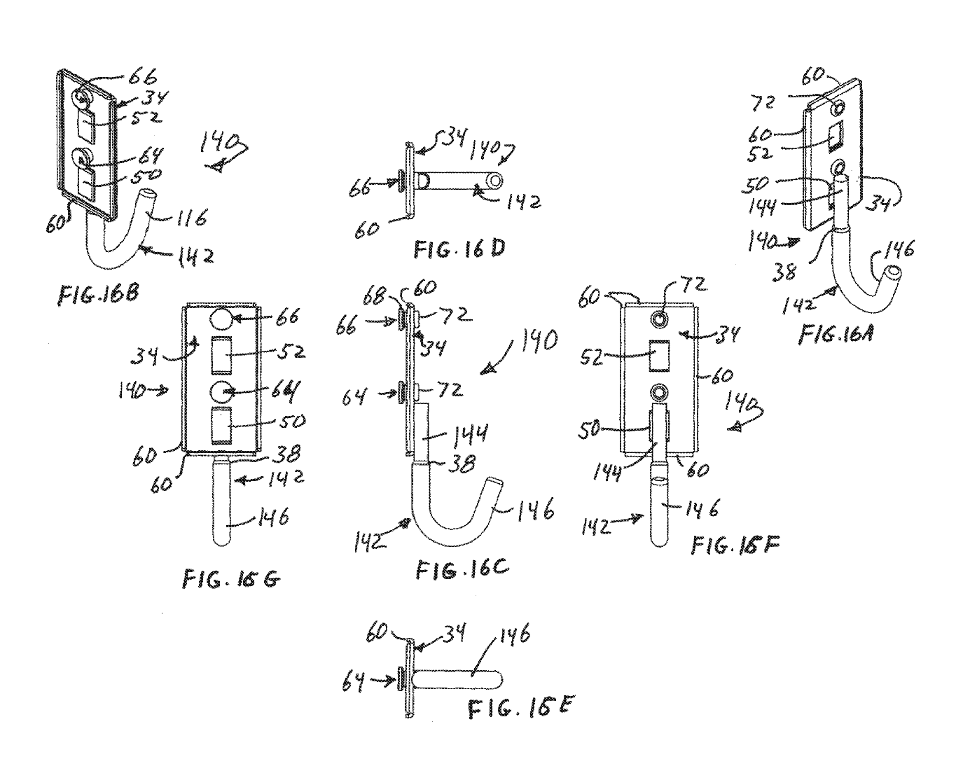

Referring to FIGS. 16A-16G, a J-hook connecting assembly 140 is provided. The basic construction of the mounting plate 34 is the same so the description of the common parts of the mounting plate is not given again. A J-hook 142 has a shaft 144 and a hook portion 146 forming a J-shaped hook. The shaft 142 is fastened to the front side of the mounting plate 34 so the hook portion 146 extends outward from the front of the mounting plate 34. The hook portion 146 extends at an angle of between about 30° from the plane of the mounting bracket 34 on one lateral side of the bracket to an angle of about 30° to that same plane on the other lateral side of the mounting bracket. The depicted J-hook 142 extends at an angle of 90° to the plane of the mounting bracket 34 and uses a single J-hook. The J-hook 142 may have two or three hook portions 146 equally spaced apart, as for example two hook portions 146 spaced 60° apart and about 30° from a plane orthogonal to the front side of the mounting plate 34.

In the depicted embodiment the shaft 144 extends over and is aligned with the first or bottom recess 50, with the hook portion 142 extending below the bottom side of the mounting plate 34. The hook portion 142 is concave as seen in the figures, and preferably a substantial part of the hook portion 142 extends below the bottom of the mounting plate 34 and more preferably all of the hook portion 142 extends below the bottom of the mounting plate. The coating 38 is applied to at least the hook portion 142.

In shaft 144 is shown with no laterally extending component for fastening to the mounting plate 34 or for rotating about a horizontal axis relative to the mounting plate as in the above described embodiments. The shaft 144 is preferably permanently fastened to the mounting plate by spot welding, rivets, threaded fasteners, adhesives, clamps, or other fastening mechanisms.

Each of the above connecting assemblies are used in basically the same way. The connectors 64, 66 pass through the enlarged portion of slots 12 and slide downward so the connector's shaft 70 seats in the narrower portion of the slot 12 in order to fasten the mounting plate 34 to the surface in which the slots 12 are formed, shown in FIGS. 1-3 as runner plate 12. In most embodiments the hook portions or arm portions are movable between a folded configuration that reduces the overall size of the assemblies, and a larger, unfolded, use configuration that places the hooks or arms in a position ready for a user to hang something on or suspend something on. The various assemblies are usable for hanging any item having straps, openings or flexible elongated members that are engageable by the various arms and hooks provided in the assemblies, including personal items such as purses, bags, backpacks, belts, scarves, household items such as ropes and electrical cords, and numerous other items that are not flexible but may be suspended by the various arms and hooks, such as suspended signs, placards, items packed in blister packs, and displays holding other items. These are illustrative uses.

The above described hook and arm assemblies provide a light weight assembly that may be made at lower costs and prior assemblies. The mounting plate 34 may be formed of a single, flat piece of material that is cut and bent to form the motion stops 56 and that is bent to form the flanges 60 and that is stamped to form the recesses 50, 52. The flanges, recesses and motion stops stiffen the mounting plate and resist deformation from the weight of items suspended on the arms or hooks connected to the mounting plate 34. The use of rivets to form connectors 64, 66 extending through holes punched through the mounting plate 34 provides a low cost, easy to make connection for the mounting plate. The mounting plate construction is simple and easy to manufacture. The support arms 30, and hooks 112, 142 are likewise simple and easy to fabricate, with rotatable connections to the mounting plate 34 also being simple to make and assemble. There is thus provided an improved assembly for connecting a variety of hooks and arms to support structures using mounting plate 34.

The slots 12 receive the interlocking connectors 64, 66, but the configuration of the connectors and slots or openings 12 may comprise other interlocking lugs and openings configured to mate with those lugs. Illustrative lugs and connectors with their receiving openings and slots are described in U.S. Pat. Nos. 1,831,550 7,497,533, each of which discloses vertical slots in shelving posts that receive downward opening hooks having a rectangular cross-section formed on the end of shelving supports; U.S. Pat. No. 1,344,327 which shows an arm with a cylindrical lug having a recess inward of its distal end to pass through a circular hole in a vertical corner post and interlock; U.S. Pat. No. 3,208,778 which has racks with outwardly and upwardly extending male projections interlocking with mating hooks or loops on mating parts. The complete contents of these above-identified patents are incorporated herein by reference.

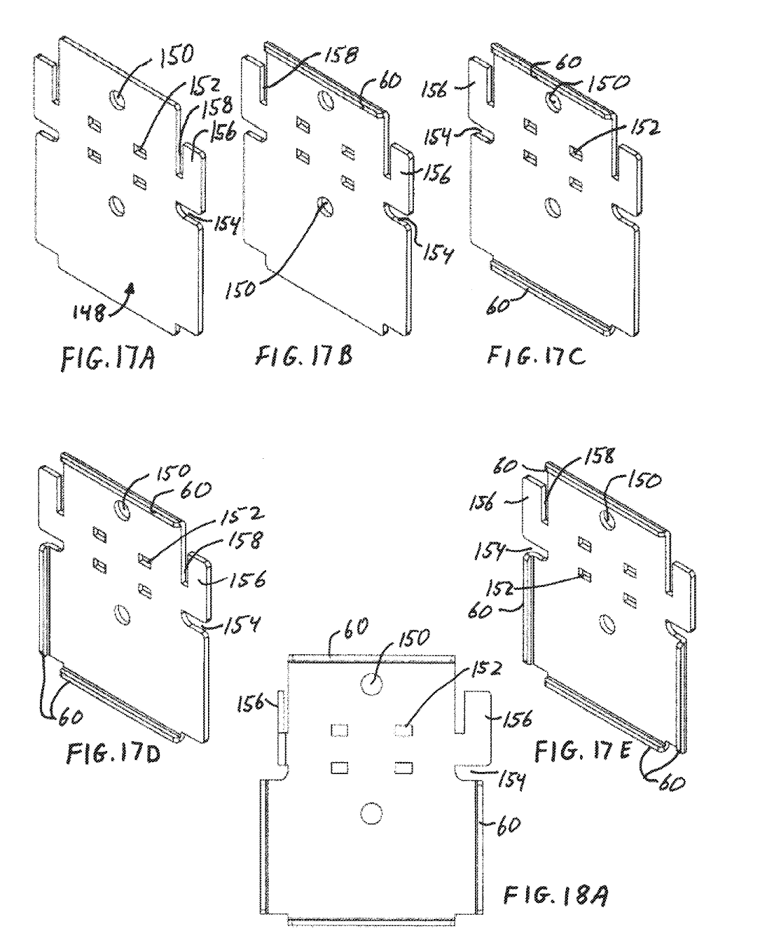

There is also provided a method of forming the mounting plate 34 to have a low profile, and simple manufacturing steps. Referring to FIGS. 17-19 and especially to FIG. 17A, a flat rectangular plate is cut and/or punched to formed the flat plate 148 depicted in FIG. 17A. Plasma cutting or mechanical punching are preferred for forming two circular holes 150 for ultimately receiving connectors 64, 66 such as rivets in the plate 148. Likewise, plasma cutting, laser cutting, water jets or mechanical punching or other forming methods are preferred for forming the holes 152 for receiving legs 42 of the retainer, with the holes 152 shown as rectangular. Plasma cutting, laser cutting, water jets or mechanical punching or other forming methods are also preferred for forming curved slots elongated slots 154 with curved ends extending laterally inward from opposing sides below L-shaped flanges 156 to form the lower legs of that flange 156, and for forming two vertical cuts or slots 158 to form the long leg of the L-shaped flange 156. Note that the longer leg of the L-shaped flange 156 does not extend to the distance of the top and bottom sides of the flat plate 148 and are shorter, as a square shaped piece of material is preferably cut off of each corner the initially rectangular plate with the removed material affecting the horizontal length of the leg 58a of stop 56, as will be apparent from the disclosure provided herein.

As seen in FIGS. 17B-17E, each side of the previously flat plate 148 is bent to form flange 60 along at least a portion of each side. No flange is formed on the L-shaped flange 156. The order in which the flanges 60 are formed on each edge is not believed critical and all flanges may be formed simultaneously, but the result shown in FIG. 17E is to form a rearwardly extending flange 60 on each side of the previously flat plate 148 (FIG. 17A). The length of flange 60 is described above, and is preferably about the thickness t of the flat plate of material 148.

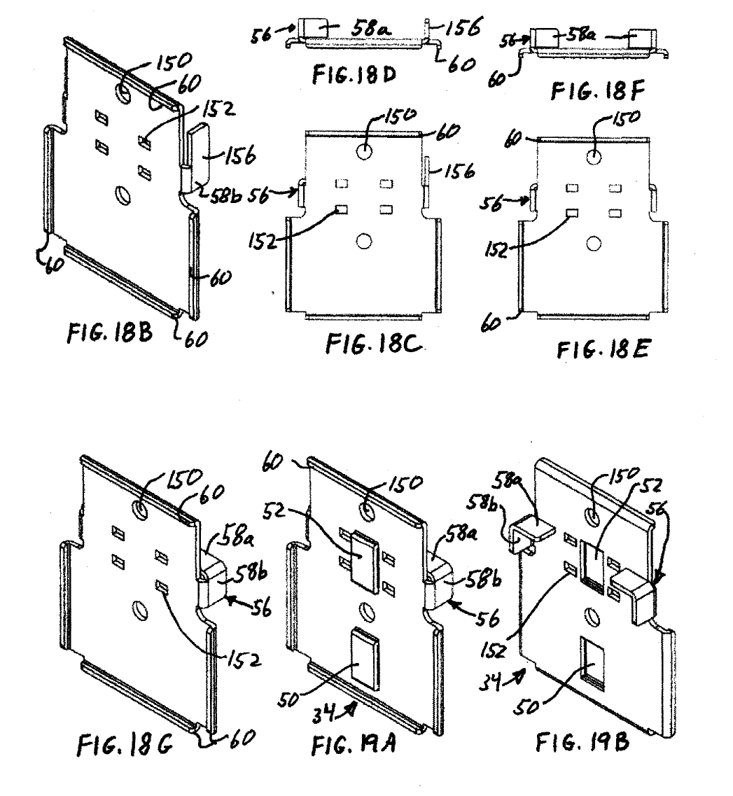

As seen in FIGS. 18A-18B, the L-shaped flanges are bent forward to be perpendicular to the plane of the main portion of the flat plate 148 (FIG. 17A), which preferably but optionally substantially removes slots 154. The order of deformation is not believed critical and both flanges may be deformed simultaneously. This deformation forms the leg 58b of stop 56. As shown in FIGS. 18C-18G, the distal end of L-shaped flange 156 is then bent parallel to the plane of the flat plate 148 (FIG. 17A) to form the legs 58 of the motion stop 56. This substantially removes the slots 158. The order in which the legs 58a, 58b are formed may vary as legs 58a may be deformed to be perpendicular to the plane of flat plate 148 before legs 58a are deformed, as subsequent deformation of legs 58a will place the leg 58a in the same final orientation as the first described deformation sequence and as shown in FIGS. 1-2.

Referring to FIGS. 19A-19B, the next step in the manufacturing sequence is preferably to form the first and second recesses 50, 52 in the planar, plate portion of the blank 148 which completes the formation of the mounting bracket 34. The recesses 50, 52 may be formed by stamping or pressing operations, or other metal deformation processes. The deformation is preferably shallow, as described above, and more preferably forms an offset of abut thickness t of the metal forming the plate 148 or 34, so the back surface of the recesses 50, 52 are in the same plane as the rearward edges of flanges 60. While the steps may be varied as discussed, the manufacturing sequence or steps are preferably in the order listed and as shown in the FIGS. 17-19 when the bracket is formed of metal. The bracket may be integrally molded of a single piece of plastic material or metal in a single casting.

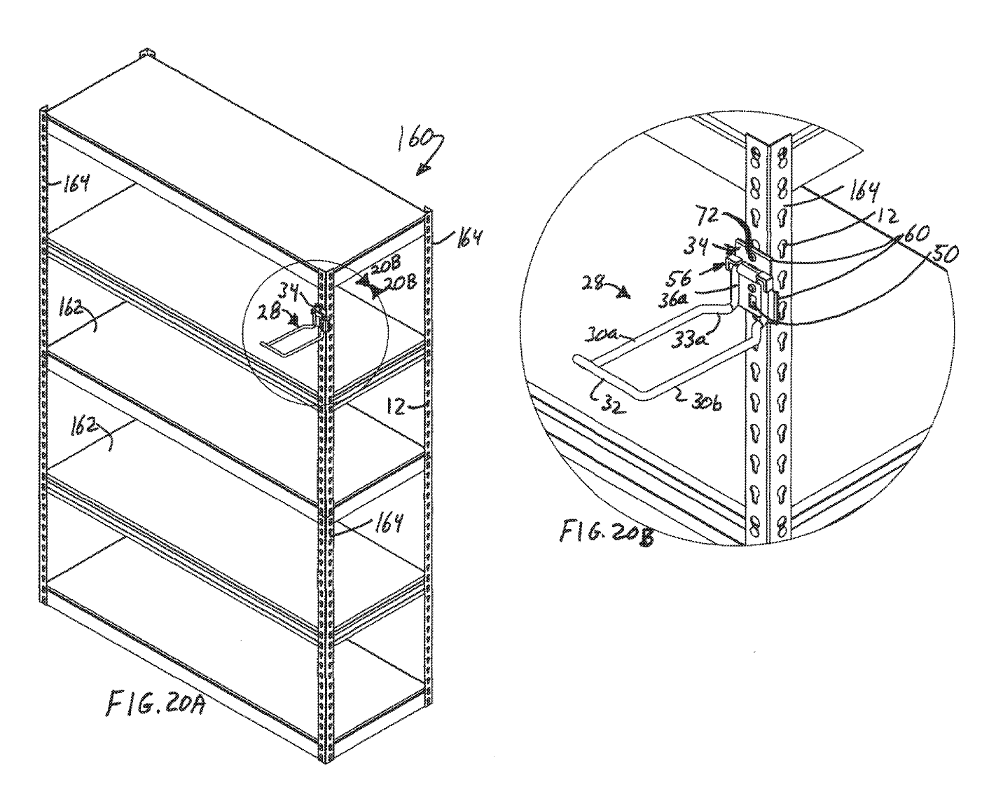

The mounting bracket 34 and connectors 64 and 66 may each engage respective openings such as slots 12, in a variety of support structures other than runner plate 10. FIGS. 20A-20B show a shelving unit 160 with a plurality of shelves 162 releasably connected to posts 164 having aligned rows of slots 12. The mounting bracket 34 and its connectors 64, 66 releasably connect to any correspondingly located pair of slots 12. It is preferable if four of the flanges 60 abut the support structure, here post 164, but in the depicted embodiment only the top and bottom flanges 60 abut the post along with recesses 50, 52.

The mounting plates 34 with various hooks and hook assemblies may be provide along, or in kits having one or more mounting assemblies provided with a shelving unit having a plurality of shelves and at least four posts as described above, or in kits having one or more mounting assemblies provided with another support for the connectors of the mounting plate as described herein.

The mounting bracket 34 is shown with a closed hook assembly 28, but any of the various arms 30a, 30b and hooks or hook assemblies described herein may be used with the mounting plate 34. The slots 12 and connectors 64, 66 are spaced apart at predetermined distances to allow the location of shelves and brackets 34 at a plurality of locations. Similar slots 12 may be placed on the vertical posts or horizontal beams of storage racks.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The above description is given by way of example, and not limitation. Given the above disclosure, one skilled in the art could devise variations that are within the scope and spirit of the invention, including various ways of configuring one or more connectors 64, 66 and their receiving slots 12 to connect the mounting plate 34 to a structural support. Further, the various features of this invention may be used alone, or in varying combinations with each other and are not intended to be limited to the specific combination described herein. Thus, the invention is not to be limited by the illustrated embodiments.

What is claimed is:

1. A bracket for releasably connecting to a support structure having a plurality of first and second shaped openings that are aligned along a first axis; the bracket comprising
a mounting plate having a periphery with opposing front and back faces and made of metal having a thickness t;
a back flange extending along a substantial portion of the periphery and extending in a rearward direction, the back flange extending a distance about the same as the thickness t;
first and second connectors aligned along a second axis that is parallel to the first axis and extending outward from the back face, each connector having an enlarged head configured to releasably interlock with corresponding ones of the first and second shaped openings, the enlarged heads being offset from the back face a distance sufficient to engage the correspond shaped opening while the flange contacts the support surface;
a first recessed surface in the front face and aligned with the second axis, the first recessed surface offset toward the back face about the same distance as the thickness t; and
a support for hanging an item, the support comprising one of a hook or arm connected to the mounting plate, a proximal rotating end of the hook or arm being at least partially encircled by a retaining part connected to the mounting plate to rotatably connect the hook or arm to the mounting plate and orientated so the hook or arm rotates in a vertical direction during use.

2. The bracket of claim 1, further comprising an insert in the first recessed surface and interposed between the first recessed surface and the proximal rotating ends, and wherein the retaining part comprises a curved plate having legs passing through the mounting plate and engaging the back side of the mounting plate.

3. The bracket of claim 1, further comprising a second recessed surface in the front face, the second recessed surface offset toward the back face about the same distance as the thickness t, the second recessed surface being aligned with the first recessed surface and with the second axis, one of the connectors being located between the two recessed surfaces.

4. The bracket of claim 1, wherein the first and second connectors each comprises a rivet extending through the mounting plate, the enlarged head being circular.

5. The bracket of claim 1, wherein the mounting plate comprises a generally rectangular shape having two opposing sides and an opposing top and bottom, the flange extending along at least a portion of each side of the generally rectangular shape.

6. The bracket of claim 5, wherein the support for hanging an item comprises a hook having a shank permanently connected to the front face of the mounting plate and having a concave hook end.

7. The bracket of claim 1, wherein the support for hanging an item comprises a pair of arms each having a proximal rotating end extending laterally and generally parallel to the front face and generally perpendicular to the second axis, each proximal rotating end being rotatably connected to the mounting plate at the first recessed surface so each arm rotates between a first, unfolded, use position in which the pair of arms are generally perpendicular to the mounting plate and a second, folded position in which the pair of arms are generally parallel to the mounting plate.

8. The bracket of claim 7, wherein each arm has a stop portion extending parallel to the second axis and joined to the proximal rotating end, the stop portion contacting the mounting plate to position the pair of arms in the first, unfolded, use position.

9. The bracket of claim 8, wherein a distal end of each pair of arms is connected.

10. The bracket of claim 8, wherein a distal end of each pair of arms is upwardly inclined and connected by a straight end piece.

11. The bracket of claim 8, wherein the proximal rotating end of each arm is permanently connected to each other.

12. The bracket of claim 8, wherein a distal end of at least one of the pair of arms has an upwardly inclined end when in the first, use position.

13. The bracket of claim 8, wherein a distal end of at least one of the pair of arms has a curve at the distal end which curve is concave when the at least one of the pair of arms is in the first, use position.

14. The bracket of claim 8, wherein a first distance separates the stop portions and a second distance separates distal ends of each of the pair of arms, the second distance being greater than the first distance.

15. The bracket of claim 14, wherein each arm is parallel for a substantial length of each arm.

16. The bracket of claim 14, wherein each arm is straight for a substantial length of each arm and the arms have an included angle of about 20° to 40°.

17. The bracket of claim 1, further comprising a motion stop extending away from the front face a distance to contact one of the stop portions and position the arm in the second position.

18. The bracket of claim 1, wherein the support for hanging an item comprises first and second hooks each located on a different side of the second axis and each having a top, straight portion extending along a lateral axis that parallel to the front surface and perpendicular to the second axis, each top, straight portion being rotatably connected to the mounting plate to rotate about that longitudinal axis, each first and second hook having a hook portion opening in a direction away from each other and depending below the bottom of the mounting plate.

19. The bracket of claim 18, further comprising:
a connecting member connecting first and second hooks to the mounting plate, the connecting member having connecting arms fastened to the mounting plate and further having a laterally extending top member and bottom member which are parallel to each other but spaced apart from each other;
first and second connecting plates located on opposing sides of the second axis, each first and second connecting plate connected to the top member and to the bottom member;
a first tubular connector fastened to a front side of the first connecting plate and a second tubular connector fastened to a front side of the second connecting plate, each top, straight portion being rotatably connected to the mounting plate by the top straight portion of the first hook rotating inside the first tubular connector and the top straight portion of the second hook rotating inside the second tubular connector.

20. The bracket of claim 19, wherein the first and second connecting plates each has a top side forming a top elongated recess which receives a portion of the top member, and wherein the first and second connecting plates each has a bottom side forming a bottom recess which receives a portion of the bottom member, the first and second hooks being on a front side of the top and bottom members, while a portion of the top and bottom elongated recess are on a back side of the top and bottom members.

21. A bracket for releasably connecting to a support structure having a plurality of first and second shaped openings that are aligned along a first axis; the bracket comprising
a generally rectangular mounting plate having opposing sides and an opposing top and bottom sides, the mounting plate having opposing front and back faces, the mounting having a thickness of about t;
a back flange extending along a substantial portion of a periphery of the mounting plate and extending along a portion of each side of the mounting plate, the back flange extending in a rearward direction a distance about the same as the thickness t;
first and second connectors aligned along a second axis that is parallel to the first axis and extending outward from the back face, each connector having an enlarged head configured to releasably interlock with corresponding ones of the first and second shaped openings, the enlarged heads being offset from the back face a distance sufficient to engage the correspond shaped opening while the flange contacts the support surface;
at least one recessed surface in the front face, the at least one recessed surface offset toward the back face about the same distance as the thickness t, the at least one recessed surface located along the first axis, the at least one recessed surface being located between the two connectors;
a pair of arms each having a proximal rotating end extending laterally and generally parallel to the front face and generally perpendicular to the second axis, each proximal rotating end being rotatably connected to the mounting plate at the first recessed surface to rotate the pair of arms vertically between a first, unfolded, use position in which the pair of arms are generally perpendicular to the mounting plate and a second, folded position in which the pair of arms are generally parallel to the mounting plate.

22. The bracket of claim 21, further comprising an insert in the at least one recessed surface and interposed between the at least one recessed surface and the proximal rotating ends, and a retainer connected to the mounting plate and encircling at least part of each proximal rotating end to rotatably connect each proximal rotating end to the mounting plate.

23. The bracket of claim 21, wherein each connector comprises a rivet extending through the mounting plate, the enlarged head being circular.
